(19) United States
(12) Patent Application Publication
(10) Pub. No.: US 2002/0006603 A1
(43) Pub. Date: Jan. 17, 2002

(54) REMOTELY ADMINISTERED COMPUTER-ASSISTED PROFESSIONALLY SUPERVISED TEACHING SYSTEM

(76) Inventors: BRET E. PETERSON, LAFAYETTE, CA (US); WILLIAM M. JENKINS, PACIFICA, CA (US); MICHAEL M. MERZENICH, SAN FRANCISCO, CA (US); PAULA TALLAL, LUMBERVILLE, PA (US); STEVEN L. MILLER, PACIFICA, CA (US)

Correspondence Address: JAMES D IVEY, 3025 TOTTERDELL STREET, OAKLAND, CA, 94611-1742, US

(21) Appl. No.: 09/108,816

(22) Filed: Jul. 1, 1998

Related U.S. Application Data
(63) Continuation-in-part of application No. 08/995,680, filed on Dec. 22, 1997, now Pat. No. 5,957,699.

(51) Int. Cl. G09B 25/00

(52) U.S. Cl. 434/365

(57) ABSTRACT

Execution status of a number of teaching processes distributed throughout a computer network are represented in a HTML document such that the status of the teaching processes can be observed remotely using a conventional HTML document viewer. In general, the status can be observed from any of a number of computers which can retrieve the HTML document through a computer network. To view the execution status of the teaching processes, an administrator uses a conventional HTML viewer to request the HTML document according to a file transfer protocol, e.g., the hypertext transfer protocol (HTTP). HTTP supports retrieval of HTML documents locally, i.e., within the computer in which a HTTP server executes, or remotely through a computer network. The HTML document includes user interface controls by which the administrator can invoke administrations tasks performed by the HTTP server. An administrator can observe the execution status of the teaching processes and can invoke administrative tasks from any of a number of computer systems.

CROSS REFERENCE TO RELATED APPLICATIONS

This application is a continuation-in-part of co-pending U.S. patent application Ser. No. 08/995,680 filed Dec. 22, 1997 by Dr. Bret Peterson et al. and entitled “Remote Computer-Assisted Professionally Supervised Teaching System.” In addition, this application is related to co-pending (1) U.S. patent application Ser. No. 08/995,964, entitled “Remote Computer-Assisted Compliance Monitoring System,” and (2) U.S. patent application Ser. No. 08/995,497, entitled “Migration Mechanism for User Data from One Client Computer System to Another,” both of which were filed Dec. 22, 1997 and which are both incorporated herein by reference in their entirety for all purposes.

### FIELD OF THE INVENTION

The present invention relates to computer-assisted teaching systems and, in particular, to a particularly effective mechanism by which a teacher, supervisor, or therapist can remotely monitor use of one or more teaching processes by a number of students or patients to thereby ensure that use of the teaching processes by the students is proper.

### BACKGROUND OF THE INVENTION

For many years, computers have been used in an educational capacity. However, computer-assisted teaching systems are tackling even larger developmental challenges to the point at which supervision by a human teacher, supervisor, or clinical psychologist is required. Such supervision includes (i) monitoring the performance of a student in terms of correctly performing tasks specified by the computer-assisted teaching system and maintaining a prescribed schedule, (ii) configuring the computer-assisted teaching system to adapt to the particular needs and abilities of the student, and (iii) using feedback from the computer-assisted teaching system to direct supplementary instruction.

Sometimes, physical presence of a supervisor at the site at which a student uses a computer-assisted teaching system is impractical. For example, such is the case in computer-assisted teaching systems in which highly-qualified clinical psychologists are required and in which relatively few students at any particular site require use of the computer-assisted teaching system. In such cases, the ability of a supervisor to supervise use of the computer-assisted teaching system from a remote location is particularly advantageous.

In addition to observing the progress in terms of cognitive ability of the student, it is important in such systems to monitor and ensure proper use of the computer-assisted teaching system by the student. For example, in computer-assisted teaching systems which are highly adaptive to the abilities of the particular student using the system, it is particularly important to ensure that each student is properly registered under his or her own identifier. Otherwise, such a system may operate at a level of difficult greatly surpassing the level of ability of the student and frustration will result to the student's detriment. Furthermore, an administrator should be able to detect and correct any discrepancies between the indicated state of the computer-assisted teaching system and the actual state.

In some systems, administration is performed centrally from a remote computer system through a computer network. However, such central administration suffers from the inability to visually observe distributed client computer systems. In other systems, administration is performed locally at client computer system sites by local administrators. However, such local administrators frequently lack the technical expertise to accurately diagnose any problems and to apply the proper remedy.

What is therefore needed is an administration mechanism by which administration tasks can be performed from any of a number of locations within a computer network.

### SUMMARY OF THE INVENTION

In accordance with the present invention, execution status of a number of teaching processes distributed throughout a computer network are represented in a HTML document such that the status of the teaching processes can be observed remotely using a conventional HTML document viewer. In general, the status can be observed from any of a number of computers which can retrieve the HTML document through a computer network. The HTML document includes icons representing whether each teaching process is in use. For example, an icon which represents a computer with an illuminated display screen and a human user seated in front of the computer indicates that the teaching process is in use. Text captions identify the teaching process, the user of the teaching process, a particular module of the teaching process, and the amount of time that has elapsed since the user began use of the particular module of the teaching process. Conversely, an icon which represents only a computer with a darkened display screen indicates that the teaching process is not in use. A text caption identifies the teaching process within the HTML document.

To view the execution status of the teaching processes, an administrator uses a conventional HTML viewer to request the HTML document according to a file transfer protocol, e.g., the hypertext transfer protocol (HTTP). HTTP supports retrieval of HTML documents locally, i.e., within the computer in which a RTTP server executes, or remotely through a computer network. Accordingly, an administrator can observe the execution status of the teaching processes from any of a number of computer systems.

The HTTP server maintains status information regarding the execution status of the teaching processes. Such information includes whether the teaching process is in use, which of a number of users is using the teaching process, which of a number of modules is in use, and the time at which use of the currently used module began. The HTTP server receives such information as messages from the teaching processes.

When use of a teaching process begins, the teaching process sends a message to the HTTP server. The message includes data identifying the teaching process and the user. When use of the teaching process completes, the teaching process sends another message to the HTTP server, identifying the teaching process and indicating that no user is using the identified teaching process. Thus, the HTTP server maintains status information specifying whether each teaching process is in use and by whom.

When use of any of a number of modules of a teaching process begins, the teaching process sends a message to the HTTP server indicating which module is being used and a time at which such use began. When use of the module completes, the teaching process sends a message to the HTTP server so indicating. Accordingly, the HTTP server also maintains status information indicating which module is currently in use and at what time such use began.

The HTIML document includes user interface controls by which the administrator can invoke administrations tasks performed by the HTTP server. Such administrative tasks include changing the status information to indicate that a particular user is using a particular one of the teaching processes or to indicate that no user is using a particular one of the teaching processes. The user interface controls can include hypertext links and buttons which send such requests using Common Gateway Interface (CGI) scripts. In response to such requests, the HTTP server performs the requested task.

Thus, in accordance with the present invention, an administrator can observe the execution status of the teaching processes and can invoke administrative tasks from any of a number of computer systems. As a result, the administrator can look over the shoulder of a user of a particular one of the teaching process and use the computer system within which the particular teaching process executes to display the execution status of the teaching processes. The administrator can compare the observation of the teaching process to the displayed status to detect any discrepancies and can invoke administration tasks from the computer system to the correct any such discrepancies. In addition, technical support can be provided remotely by granting remotely located technical experts access to the HTML document through the HTTP server. The experts can therefore display execution status of the teaching processes and can modify such status using the administrative tasks.

### BRIEF DESCRIPTION OF THE DRAWINGS

FIG. 1 is a block diagram of a teaching process manager which provides execution status and administrative tasks in accordance with the present invention.

FIG. 2 is a block diagram of a usage database of the teaching process manager of FIG. 1 in greater detail.

FIG. 3 is a block diagram of a remote server computer system, a number of student client computer systems, a local server computer system, and a supervisor client computer system in which the student client computer systems and local server computer system are coupled to one another through an intranet.

FIG. 4 is a block diagram of the remote and local server computer systems and supervisor and student computer systems of FIG. 3 in greater detail.

FIG. 5 is a block diagram of a student administration database of FIG. 1 in greater detail.

FIG. 6 is a block diagram of a student administration record of FIG. 5 in greater detail.

FIG. 7 is a logic flow diagram of the registration of a student by the teaching process manager of FIG. 4.

FIG. 8 is a logic flow diagram of the un-registration of a student by the teaching process manager of FIG. 4.

FIG. 9 is a block diagram of a client record representing a student within a student response database of FIG. 2.

FIG. 10 is a block diagram of a machine record representing a student client computer system of FIG. 2.

FIG. 11 is a block diagram of a data file of the student response database of FIG. 2.

FIG. 12 is a block diagram of a data entry of the student response database of FIG. 2.

FIG. 13 is a block diagram of a data version of the student response database of FIG. 2.

FIG. 14 is a block diagram of a game record of the configuration database of FIG. 2.

FIG. 15 is a block diagram of a category record of the configuration database of FIG. 2.

FIG. 16 is a block diagram of a level record of the configuration database of FIG. 2.

FIG. 17 is a logic flow diagram illustrating packing of student user data for migration from one student client computer system to another.

FIG. 18 is a logic flow diagram illustrating unpacking of student user data for migration from one student client computer system to another.

FIG. 19 is a block diagram of a packed student record formed in accordance with the logic flow diagram of FIG. 17.

FIG. 20 is a block diagram of a packed game record of the packed student record of FIG. 19.

FIG. 21 is a logic flow diagram of the processing of the teaching process manager of FIG. 1 in response to a start server message in accordance with the present invention.

FIG. 22 is a logic flow diagram of the processing of the teaching process manager of FIG. 1 in response to a stop server message in accordance with the present invention.

FIG. 23 is a logic flow diagram of the processing of the teaching process manager of FIG. 1 in response to a download student data message in accordance with the present invention.

FIG. 24 is a logic flow diagram of the processing of the teaching process manager of FIG. 1 in response to an upload student data message in accordance with the present invention.

FIG. 25 is a logic flow diagram of the processing of the teaching process manager of FIG. 1 in response to a start module message in accordance with the present invention.

FIG. 26 is a logic flow diagram of the processing of the teaching process manager of FIG. 1 in response to a stop module message in accordance with the present invention.

FIG. 28 is a logic flow diagram of the processing of the teaching process manager of FIG. 1 in response to a get student message in accordance with the present invention.

FIG. 29 is a logic flow diagram of the processing of the teaching process manager of FIG. 1 in response to a put student message in accordance with the present invention.

FIG. 30 is a display screen view of a status HTML document of FIG. 1 in accordance with the present invention.

FIG. 31 is a second display screen view of the status HTML document of FIG. 1 in accordance with the present invention.

FIG. 32 is a display screen view of a host administration HTML document of FIG. 1 in accordance with the present invention.

FIG. 33 is a display screen view of a top level HTML document of FIG. 1 in accordance with the present invention.

### DETAILED DESCRIPTION

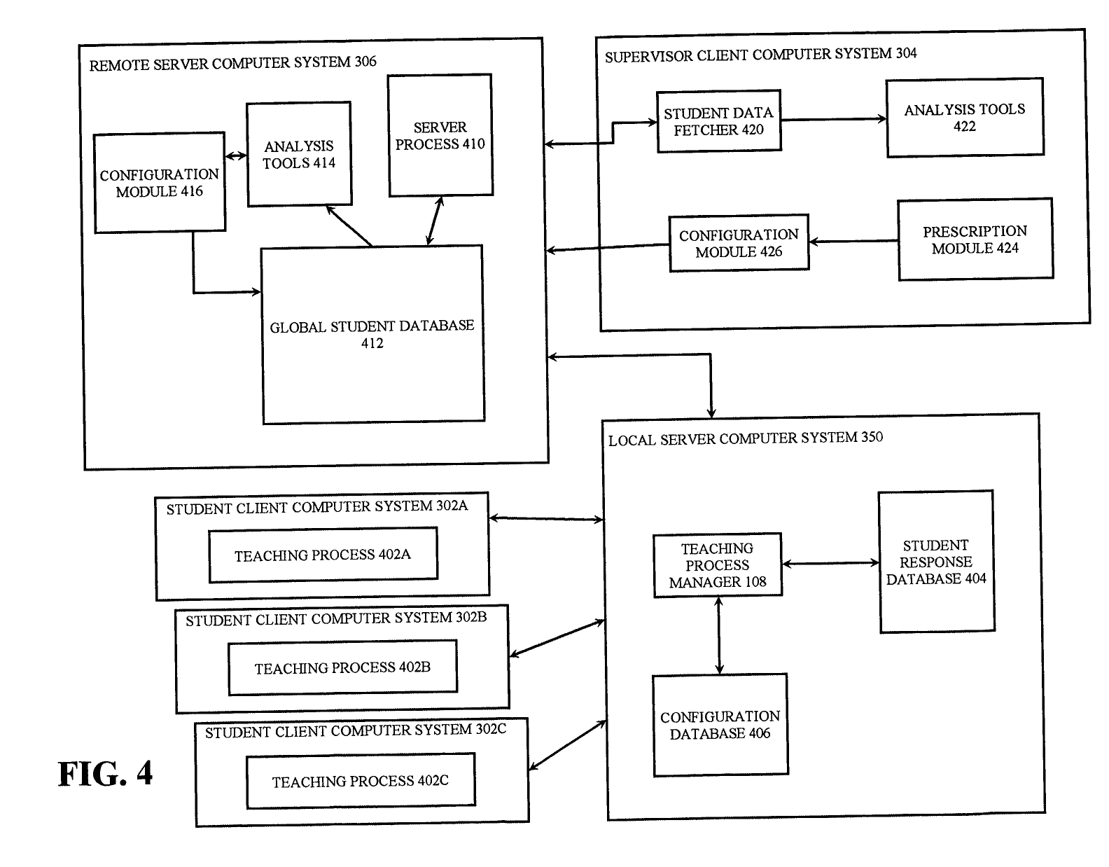

In accordance with the present invention, a teaching process manager 108 (FIG. 4) facilitates local administration of a remotely-controlled, computer-assisted teaching or compliance monitoring system. The system is described first as a teaching system and application of the same principles to a compliance monitoring system is described below. Teaching process manager 108 allows a local administrator to control aspects of the use of the teaching system by students of a particular site, e.g., the site of the local area network of local server computer system 350 and student client computer systems 302A-C. In one embodiment, the aspects controlled through teaching process manager 108 are those which are directly observable at the site by a human administrator. Such aspects include verifying that each student is registered using the appropriate student identifier, monitoring progress of students with respect to scheduled use of the teaching system, and recovery from invalid teaching system states.

The system is controlled with a remote server computer system 306 which includes a global student database 412 which maintains status and performance data for each of a number of students authorized to use the teaching system. The status and performance data can be examined through remote server computer system 306 or a supervisor client computer system 304 to evaluate performance of individual students. The advantages of such remote monitoring and evaluation are described more completely below. However, since many of the students using the teaching system described more completely below may have very little expertise in the use of computers and/or computer networks, it is particularly helpful to have a local systems administrator supervise local use of student client computer systems 302A-C.

Teaching Process Manager 108

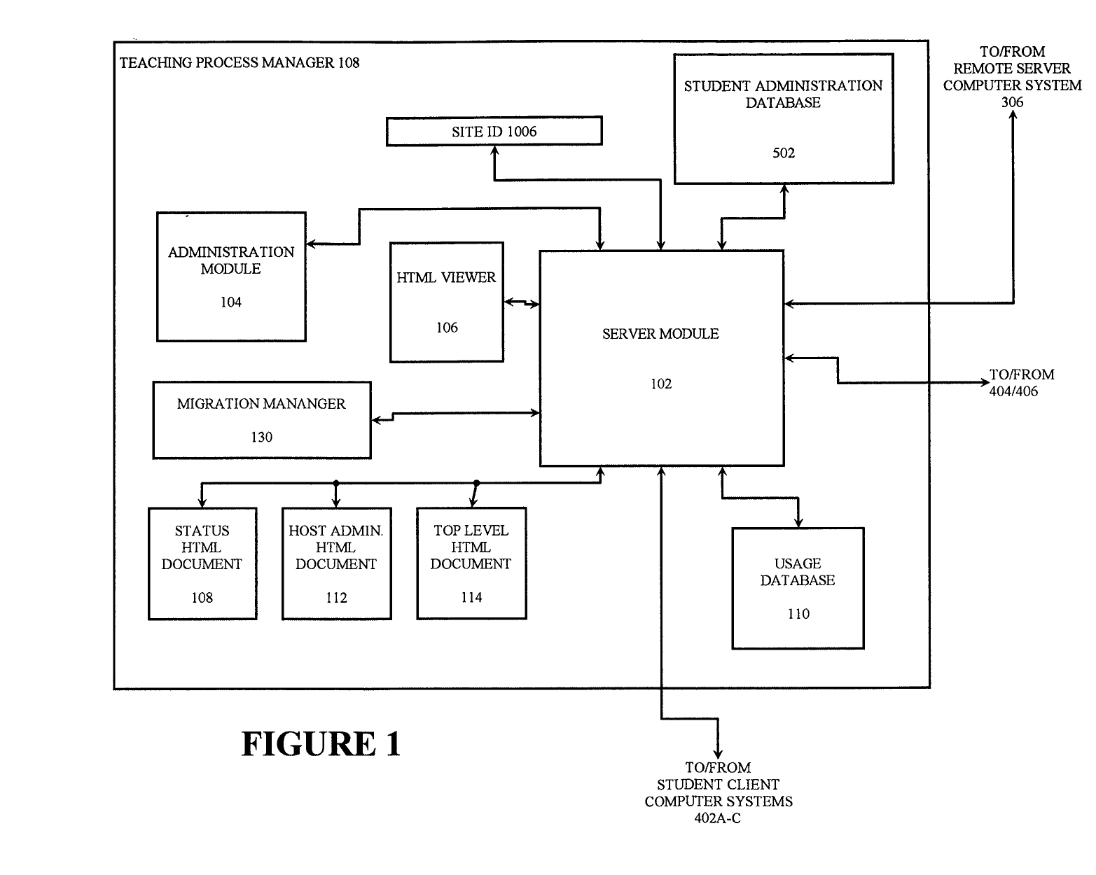

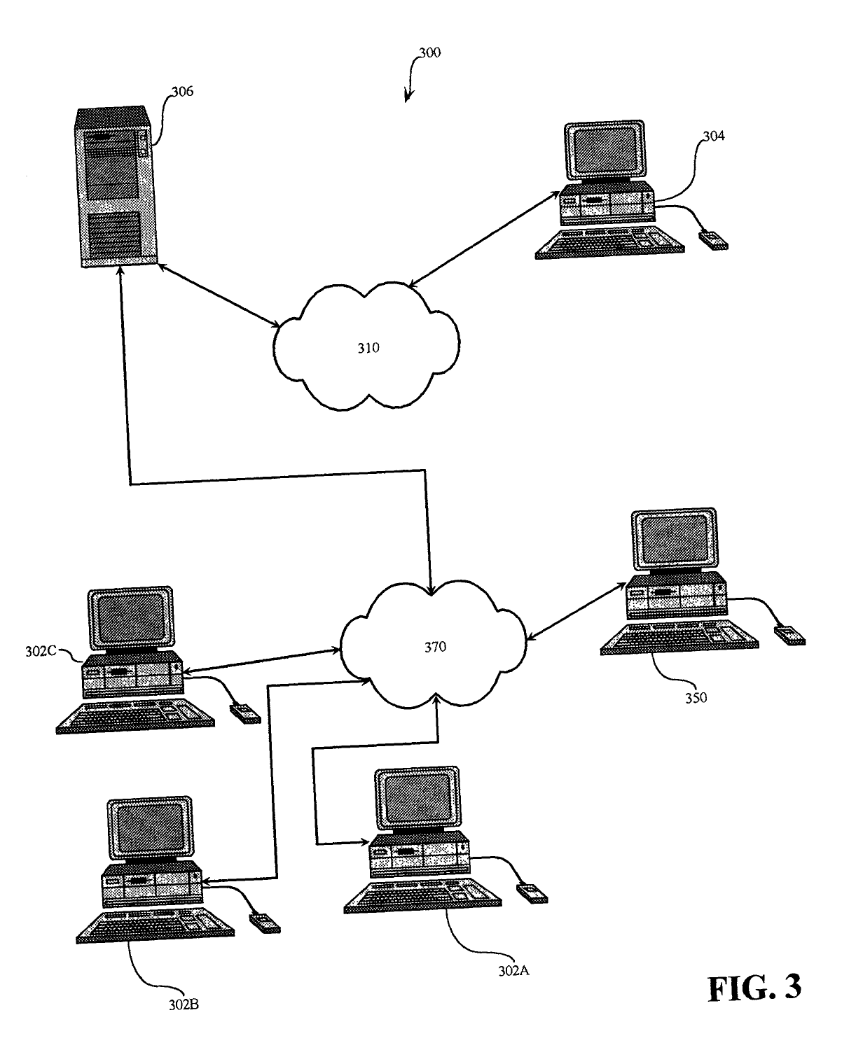

Teaching process manager 108 is shown in greater detail in FIG. 1. Teaching process manager 108 includes a server module 102 which performs the local administration tasks of teaching process manager 108. In this illustrative embodiment, server module 102 is a World Wide Web server (sometimes referred to herein as a web server) which is capable of receiving and serving Hypertext Transfer Protocol (HTTP) requests from an administration module 3304 of teaching process manager 108 and from other computer processes through computer network 370 (FIG. 3), e.g., server process 410 (FIG. 4) of remote server computer system 306. As a result, server module 102 (FIG. 1) can serve local administration requests from any computer coupled to computer network 370 (FIG. 3). The full advantage of such flexibility in the source of requests served by server module 102 (FIG. 1) is appreciated more completely in the context of the specific requests served by server module 102.

Server module 102 generally operates in two modes, one in which teaching processes 402A-C (FIG. 4) are being served and another in which teaching processes 402A-C are not being served. Upon start-up, server module 102 (FIG. 1) is in the former mode. A local administrator, using conventional user interface techniques such as a menu system, causes administration module 104 to send a request to server module 102 to switch to the latter mode.

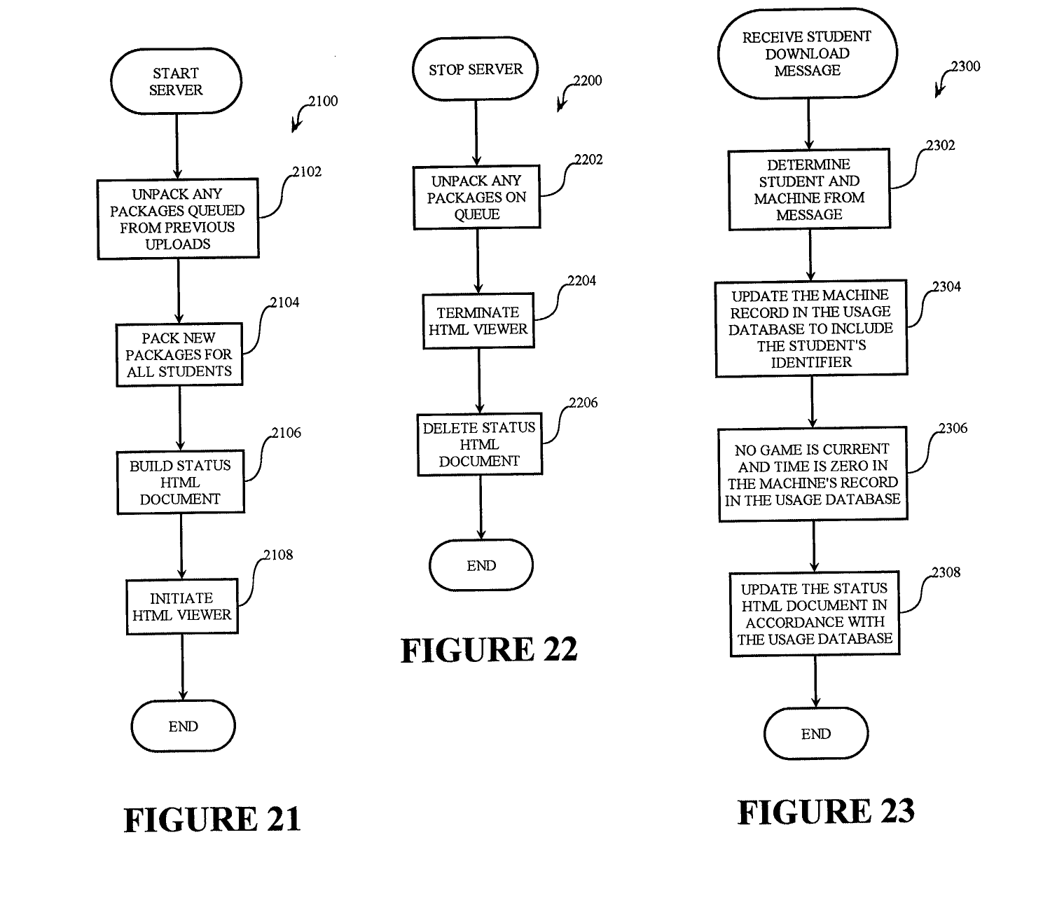

In response to the request, server module 102 performs the steps of logic flow diagram 2100 (FIG. 21).

In step 2102, server module 102 (FIG. 1) unpacks any packages which have been received since the most recent time server module 102 served teaching processes 402A-C (FIG. 4). Packing and unpacking of packages are described more completely below. Briefly, a package is all data relevant to a particular student, including performance and configuration data, in a transportable form. When a particular student begins use of any of teaching processes 402A-C, the student's data is packed into a package and the package is downloaded to the one of teaching processes 402A-C used by the student. The uploaded package is unpacked and the student's data is incorporated into student response database 404 and configuration database 406, both of which are described in greater detail below. When use of the teaching process is complete, the student's data is packed again and uploaded to server module 102 (FIG. 1), including any new configuration and/or performance data. By unpacking any packages received while not serving teaching processes 402A-C (FIG. 4), server module 102 (FIG. 1) ensures that all student data is ultimately included in student response database 404 (FIG. 4) and configuration database 406.

In step 2104 (FIG. 21), server module 102 (FIG. 1) packs student data for all students authorized to use teaching processes 402A-C (FIG. 4), i.e., all students registered within the site of local area network 370 (FIG. 3) and computer systems 302A-C and 350. Sites are described more completely below. Briefly, a site is one or more computer systems administered by a single system administrator. By packing data for all students, server module 102 (FIG. 1) prepares for downloading packages of student data as students begin use of teaching processes 402A-C (FIG. 4).

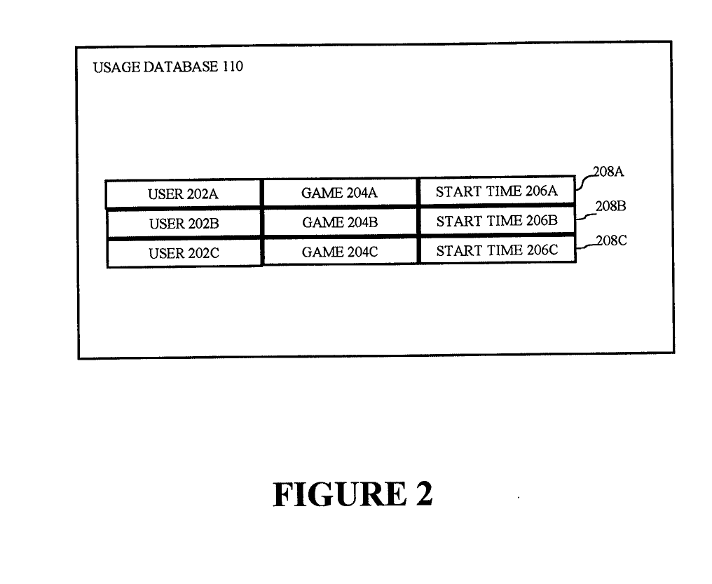

In step 2106 (FIG. 21), server module 102 (FIG. 1) builds a status hypertext mark-up language (HTML) document 108 to represent the current status of teaching processes 402A-C. Server module 102 maintains data representing such status in a usage database 110 which is shown in greater detail in FIG. 2. Usage database 110 includes a number of records 208A-C which represent respective states of teaching processes 402A-C and each of which includes a number of fields. Records 208A-C are analogous to one another and the following description of record 208A is equally applicable to records 208B-C.

Record 208A includes a user field 202A, a game record 204A, and a start time field 206A. User field 202A stores data identifying the particular student using teaching process 402A. Game record 204A stores data specifying a particular module of teaching process 402A which is currently in use by the student. Start time field 206A stores data representing the time at which use of the particular module began. In one embodiment, records 208A-C are all initialized to indicate that no user is currently using any of teaching processes 402A-C in step 2106 (FIG. 21). In an alternative embodiment, records 208A-C are not initiated since server module 102 (FIG. 1) is prevented from terminating service of teaching processes 402A-C if any student continues to use any of teaching processes 402A-C.

Status HTML document 108 represents the status of teaching processes 402A-C as represented in usage database 110 in a form which can be displayed using any conventional HTML viewer such as HTML viewer 106, which can be the Navigator HTML viewer available from Netscape Communications Corp. of Sunnyvale, California. Such a display includes display 3102 (FIG. 31). Display 3102 includes a banner 3016B which indicates that server module 102 (FIG. 1) is currently serving teaching processes 402A-C and icons representing the state of each of teaching processes 402A-C. For example, icon 3012 (FIG. 31) shows an unattended computer with a dark screen to indicate that no student is currently using teaching process 402B. Text 3014 identifies icon 3012 as corresponding to teaching process 402B. Initially, no students are using any of teaching processes 402A-C so all icons would appear as does icon 3012. Other components of display 3102 are described more completely below.

After step 2108 (FIG. 21), service of a start server message by server module 102 (FIG. 1) completes.

When an administrator would like to perform certain administrative tasks described more completely below, the administrator switches server module 102 to the mode in which teaching processes 402A-C are not served. To do so, the administrator uses conventional user interface techniques to cause administration module 104 to send a stop server message to server module 102. Processing by server module 102 in response to the stop server message is shown as logic flow diagram 2200 (FIG. 22).

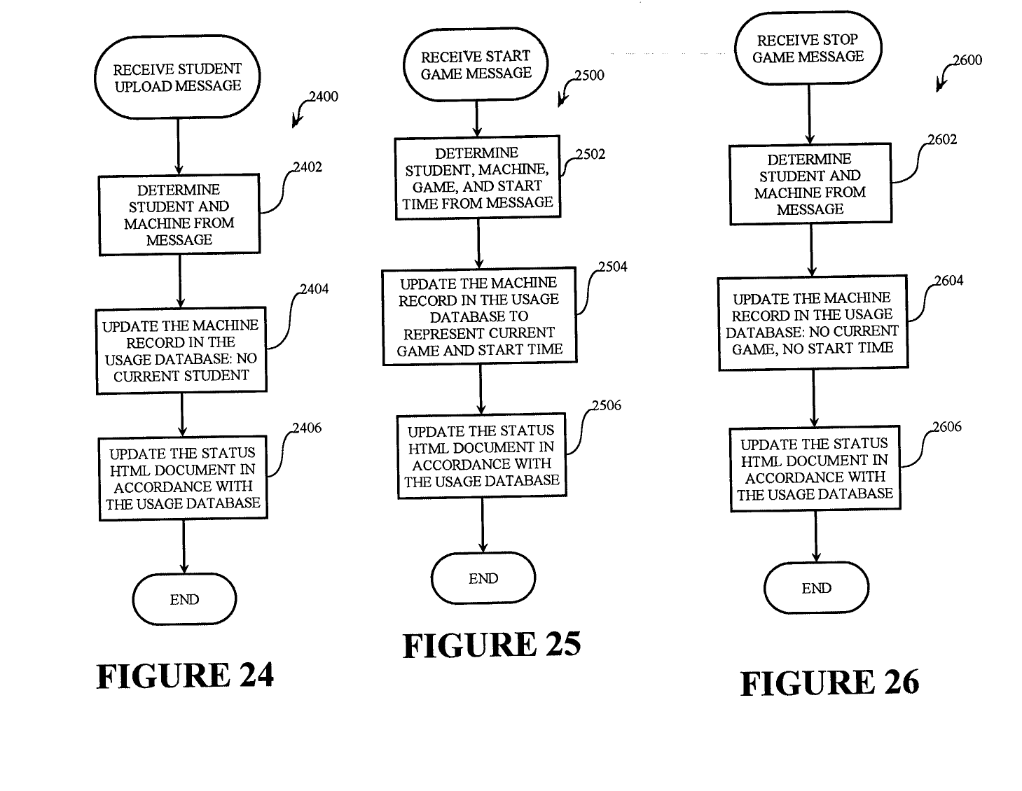

In step 2202, server module 102 (FIG. 1) unpacks any packages of student data which has been received but not yet processed by server module 102. Processing of received student data packages by server module 102 is described below in the context of logic flow diagram 2400 (FIG. 24). In processing any such received packages of student data, server module 102 (FIG. 1) indicates that the corresponding students are no longer using the one of teaching processes 402A-C to which the student data pertains. In one embodiment, processing transfers from step 2202 (FIG. 22) to step 2204 and any students currently using any of teaching processes 402A-C are permitted to continue such use. Any packed student data subsequently received by teaching process manager is stored in a queue for subsequent processing in the manner described above with respect to step 2102 (FIG. 21). In an alternative embodiment, after step 2202 (FIG. 22), server module 102 (FIG. 1) determines whether any students are using any of teaching processes 402A-C by reference to usage database 110 and aborts processing according to logic flow diagram 2200 (FIG. 22) if any student is using any of teaching processes 402A-C. Accordingly, server module 102 (FIG. 1) ensures the no student is using any of teaching processes 402A-C prior to terminating service of teaching processes 402A-C in this alternative embodiment.

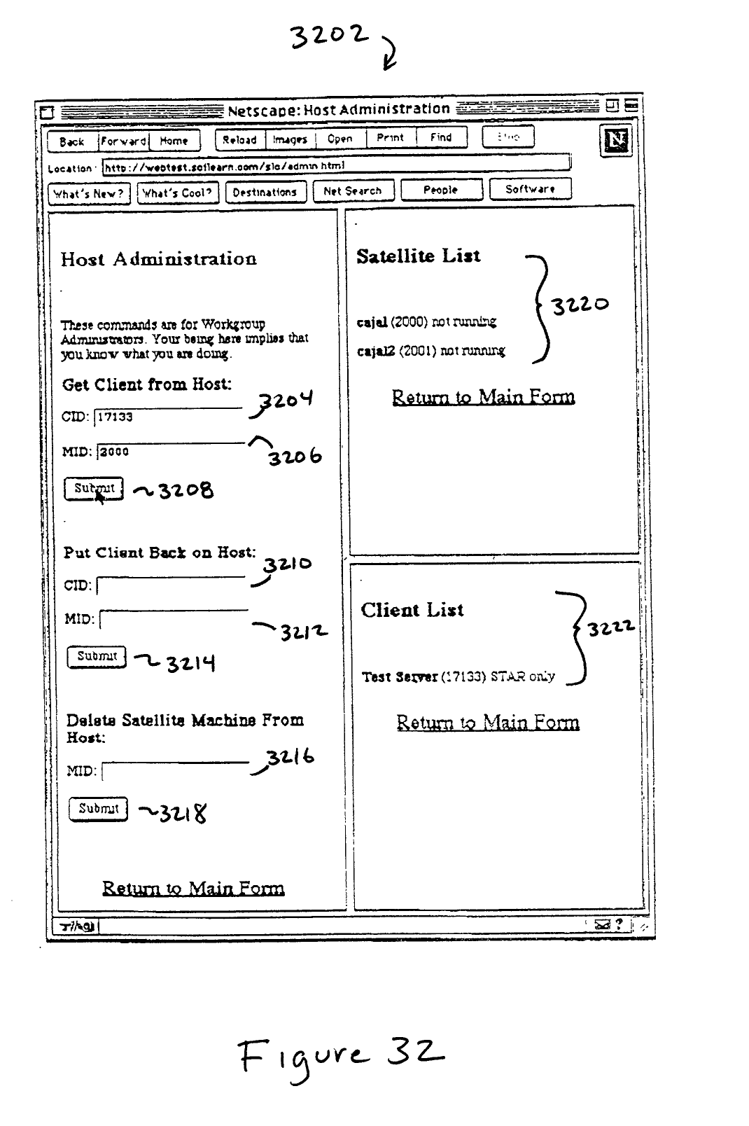

In step 2204 (FIG. 22), server module 102 (FIG. 1) terminates HTML viewer 106. In an alternative embodiment, server module 102 permits HTML viewer 106 to continue to execute while server module 102 is in the mode in which teaching processes 402A-C are not serviced. In this alternative embodiment, server module 102 changes status HTML document 108 by replacing banner 3016B (FIG. 31) with banner 3016 (FIG. 30) which indicates that server module 102 (FIG. 1) is no longer serving teaching processes 402A-C. In addition, status HTML document 108 includes buttons 3018-3022 which permit the administrator to cause server module 102 to perform specific administration tasks as described more completely below.

In step 2206 (FIG. 22), server module 102 (FIG. 1) deletes status HTML document 108 to indicate that teaching processes 402A-C are no longer being served. In the alternative embodiment in which step 2204 is skipped by server module 102, step 2206 is also skipped.

After step 2206 (FIG. 22), processing by server module 102 (FIG. 1) in ceasing service of teaching processes 402A-C is completed.

Server module 102 receives messages from teaching processes 402A-C which inform server module 102 with respect to status changes in teaching processes 402A-C. To maintain status information for each of teaching processes 402A-C, each of teaching processes 402A-C send messages to server module 102 at the following events: download by a student of a package of student data to begin use of one of teaching processes 402A-C, upload by a student of a package of student data to terminate use of one of teaching processes 402A-C, start of use of a module of any of teaching processes 402A-C by a student, and termination of use of a module of any of teaching processes 402A-C by a student. Processing by server module 102 in response to each type of message from any of teaching processes 402A-C is described in turn.

Processing by server module 102 in response to a download student data message is illustrated by logic flow diagram 2300 (FIG. 23). In step 2302, server module 102 (FIG. 1) parses from the message data identifying (i) the particular one of teaching processes 402A-C which sent the message and (ii) the identifier of the student whose data is to be packed and downloaded. In the context of logic flow diagram 2300 (FIG. 23), the sender of the message is the subject teaching process and the student identifier parsed from the message identifies the subject student.

In step 2304, server module 102 (FIG. 1) updates the one of records 208A-C (FIG. 2) which corresponds to the subject teaching process to indicate that subject student is using the subject teaching process. In this illustrative example, record 208A corresponds to the subject teaching process. Server module 102 (FIG. 1) stores the identifier of the subject student in user field 202A (FIG. 2). In step 2306 (FIG. 23), server module 102 (FIG. 1) initializes game field 204A (FIG. 2) to indicate that the subject student is not currently using any particular module of the subject teaching process and initializes start time field 206A to indicate no start time. In an alternative embodiment, start time field 206A is not initialized and any data stored in start time field 206A is considered invalid if game field 204A stores data indicating that the subject student is not using any particular module within the subject teaching process.

In step 2308 (FIG. 23), server module 102 (FIG. 1) updates status HTML document 108 to represent the current state of teaching processes 402A-C as represented in usage database 110 after step 2306 (FIG. 23). In an alternative embodiment, server module 102 (FIG. 1) updates status HTML document 108 periodically, independently of receipt of student download messages.

In either case, server module 102 updates status HTML document 108 by including in status HTML document 108 an icon 3004 (FIG. 30) which represents the subject teaching process by unique identifier 3006 and/or by relative position within display 3002 to correspond generally to the physical placement of the student client computer system within which the subject teaching process executes. Icon 3004 is shown to have an illuminated screen and a user facing the computer represented in icon 3004. In addition, server module 102 (FIG. 1) includes in status HTML document 108 text caption 3008 which represents the unique identifier of the subject student and the particular module of the subject teaching process in use by the subject student.

Since, in logic flow diagram 2300 (FIG. 23), there is no such particular module currently in use, text caption 3008 (FIG. 30) would so indicate. Server module 102 (FIG. 1) also includes in status HTML document 108 a text caption 3010 (FIG. 30) which indicates the amount of time which has elapsed since the subject student has commenced use of the particular module identified in text caption 3008. When no such module is indicated in text caption 3008, text caption 2410 indicates no time has elapsed or, alternatively, is blank.

Thus, in step 2308 (FIG. 23), whether performed in response to a download student data message or independently of any such message, server module 102 (FIG. 1) represents the status of the subject teaching process in status HTML document 108 such that display represents to the local administration that the subject student is currently using the subject teaching process. After step 2308 (FIG. 23), processing according to logic flow diagram 2300 completes.

When a student terminates use any of teaching processes 402A-C (FIG. 4), that teaching process packs the student's response and configuration data and initiates uploading to local server computer system 350 of the package of student data by sending an upload student data message. In response to receipt of such a message, server module 102 (FIG. 1) uploads the package and updates the represented status of teaching processes 402A-C in the manner shown in logic flow diagram 2400 (FIG. 24).

In step 2402, server module 102 (FIG. 1) parses from the message data identifying (i) the particular one of teaching processes 402A-C which sent the message and (ii) the identifier of the student whose data is to be uploaded and unpacked. In the context of logic flow diagram 2400 (FIG. 24), the sender of the message is the subject teaching process and the student identifier parsed from the message identifies the subject student.

In step 2404, server module 102 (FIG. 1) updates the one of records 208A-C (FIG. 2) which corresponds to the subject teaching process to indicate that subject student is using the subject teaching process. In this illustrative example, record 208B corresponds to the subject teaching process. Server module 102 (FIG. 1) stores data representing no student in user field 202B (FIG. 2) to indicate that no student is currently using the subject teaching process. In addition, server module 102 (FIG. 1) initializes game field 204B (FIG. 2) to indicate that no particular module of the subject teaching process is currently being used and initializes start time field 206B to indicate no start time. In an alternative embodiment, start time field 206B is not initialized and any data stored in start time field 206B is considered invalid if game field 204B stores data indicating that the subject student is not using any particular module within the subject teaching process.

In step 2406 (FIG. 24), server module 102 (FIG. 1) updates status HTML document 108 to represent the current state of teaching processes 402A-C as represented in usage database 110 after step 2404 (FIG. 24). In an alternative embodiment, server module 102 (FIG. 1) updates status HTML document 108 periodically, independently of receipt of student upload messages.

In either case, server module 102 updates status HTML document 108 by including in status HTML document 108 an icon 3014 (FIG. 30) which represents the subject teaching process by unique identifier 3016 and/or by relative position within display 3002 to correspond generally to the physical placement of the student client computer system within which the subject teaching process executes. Icon 3014 is shown to have a darkened screen and no user facing the computer represented in icon 3014. In addition, server module 102 (FIG. 1) includes in status HTML document 108 text captions such as text captions 3008 (FIG. 30) and 3010 are omitted from the space below icon 3014 to represent that no student is currently using the teaching process represented by icon 3014 as well as any particular module of that teaching process.

Thus, in step 2406 (FIG. 24), whether performed in response to an upload student data message or independently of any such message, server module 102 (FIG. 1) represents the status of the subject teaching process in status HTML document 108 such that display represents to the local administration that no student is currently using the subject teaching process. After step 2406 (FIG. 24), processing according to logic flow diagram 2400 completes.

While a student uses one of teaching processes 402A-C (FIG. 4), e.g., teaching process 402A, such use can involve any of a number of modules within the teaching process. As described more completely below, teaching processes 402A-C include a number of modules in the form of games which are designed to improve various cognitive abilities of students in one illustrative embodiment. In this illustrative embodiment, each student is to play each of a number of the games for a prescribed period of time. Accordingly, the particular game being played by a particular student and the amount of time that has elapsed during play of that particular game are useful information for monitoring the progress of the student and for approximating future availability of a particular one of teaching processes 402A-C for another student. To maintain such status information in usage database 110 (FIG. 1) and status HTML document 108, and therefore display 3002 (FIG. 30), teaching processes 402A-C send messages to server module 102 (FIG. 1) when starting and when stopping individual modules of teaching processes 402A-C. Such messages include an identifier of the teaching process sending the message, an identifier of the module, and whether the module is started or stopped. The message can also include an identifier of the student using the identified teaching process. In response to receiving a message indicating starting of a module, server module 102 updates status information in the manner illustrated in logic flow diagram 2500 (FIG. 25).

In step 2502, server module 102 (FIG. 1) parses from the message data identifying (i) the particular one of teaching processes 402A-C which sent the message, i.e., the subject teaching process; (ii) the identifier of the student using the subject teaching process, i.e., the subject student; (iii) an identifier of the particular module started by the subject student, i.e., the subject module; and (iv) data representing the time at which the subject module started, i.e., the subject start time.

In step 2504 (FIG. 25), server module 102 (FIG. 1) updates the one of records 208A-C (FIG. 2) which corresponds to the subject teaching process to indicate that subject student is using the subject teaching process. In this illustrative example, record 208A corresponds to the subject teaching process. In one embodiment, server module 102 (FIG. 1) assumes that the student identified in user field 202A as established in step 2304 (FIG. 23) in the manner described above is assumed to be current and correct. In an alternative embodiment, such is verified by server module 102 (FIG. 1) by comparison of user field 202A to the identifier of the subject student parsed in step 2502 (FIG. 25). Server module 102 (FIG. 1) stores data representing the subject module and the subject start time in game field 204A (FIG. 2) and start time field 206A, respectively.

In step 2506 (FIG. 25), server module 102 (FIG. 1) updates status HTML document 108 to represent the current state of teaching processes 402A-C as represented in usage database 110 after step 2504 (FIG. 25). In an alternative embodiment, server module 102 (FIG. 1) updates status HTML document 108 periodically, independently of receipt of start module messages.

In either case, server module 102 updates status HTML document 108 in step 2504 (FIG. 25) to include in text caption 3008 (FIG. 30) the identifier of the subject module in the icon of the subject teaching process, e.g., icon 3004. In addition, server module 102 (FIG. 1) updates text caption 3010 (FIG. 30) to represent an amount of time that has elapsed since the subject start time. As a result, the local administrator is provided with information regarding the particular module of the subject teaching process in use by the subject student and the amount of time during which the subject student has been using that particular module. The local administrator can use such information to more accurately predict future availability of the subject teaching process and to provide a simple means for verification of such information, e.g., by physically observing the subject student.

Thus, in step 2506 (FIG. 25), whether performed in response to a start module message or independently of any such message, server module 102 (FIG. 1) represents the status of the subject teaching process in status HTML document 108 such that display represents to the local administration that the subject student is currently using the subject module of the subject teaching process. After step 2506 (FIG. 25), processing according to logic flow diagram 2500 completes.

Processing by server module 102 (FIG. 1) in response to a message indicating that a particular student has stopped use of a particular module of one of teaching processes 402A-C is illustrated by logic flow diagram 2600 (FIG. 26).

In step 2602, server module 102 (FIG. 1) parses from the message data identifying (i) the particular one of teaching processes 402A-C which sent the message, i.e., the subject teaching process, and (ii) the identifier of the student using the subject teaching process, i.e., the subject student.

In step 2604, server module 102 (FIG. 1) updates the one of records 208A-C (FIG. 2) which corresponds to the subject teaching process to indicate that subject student is using the subject teaching process. In this illustrative example, record 208A corresponds to the subject teaching process. In one embodiment, server module 102 (FIG. 1) assumes that the student identified in user field 202A as established in step 2304 (FIG. 23) in the manner described above is assumed to be current and correct. In an alternative embodiment, such is verified by server module 102 (FIG. 1) by comparison of user field 202A to the identifier of the subject student parsed in step 2602 (FIG. 26). Server module 102 (FIG. 1) stores in game field 204A (FIG. 2) data which indicates that the subject student is not using any particular module of the subject teaching process and stores in start time field 206A data representing no time.

In step 2606 (FIG. 26), server module 102 (FIG. 1) updates status HTML document 108 to represent the current state of teaching processes 402A-C as represented in usage database 110 after step 2604 (FIG. 26). In an alternative embodiment, server module 102 (FIG. 1) updates status HTML document 108 periodically, independently of receipt of stop module messages.

In either case, server module 102 updates status HTML document 108 in step 2604 (FIG. 26) to omit from text caption 3008 (FIG. 30) any identifier of any teaching process module in the icon of the subject teaching process, e.g., icon 3004. In addition, server module 102 (FIG. 1) updates text caption 3010 (FIG. 30) to represent no amount of time, e.g., to be blank. As a result, the local administrator is informed that the subject student is no longer using any particular module of the subject teaching process.

Thus, in step 2606 (FIG. 26), whether performed in response to a stop module message or independently of any such message, server module 102 (FIG. 1) represents the status of the subject teaching process in status HTML document 108 such that display represents to the local administration that the subject student is not currently using any particular module of the subject teaching process. After step 2606 (FIG. 26), processing according to logic flow diagram 2600 completes.

As described briefly above, updating of status HTML document 108 (FIG. 1) can be either in response to any of a number of messages which represent changes in the status represented within status HTML document 108 or periodically regardless of receipt of any such messages. In either case, status HTML document 108, whose contents define display 3002 (FIG. 30), includes a redraw button 3024. Actuation of redraw button 3024 through HTML viewer 106 (FIG. 1) using conventional techniques by the local administrator sends a message to server module 102 which causes server module 102 to update status HTML document 108 to accurately represent the current status of teaching processes 402A-C as represented in usage database 110.

Status HTML document 108 (FIG. 1) also includes buttons 3018-3022 (FIG. 30). Actuation of button 3018 causes server module 102 (FIG. 1) to start serving teaching processes 402A-C in the manner described above with respect to logic flow diagram 2100 (FIG. 21). Actuation of button 3020 (FIG. 30) causes server module 102 (FIG. 1) to update global student database 412 (FIG. 4) from student response database 404 and configuration database 406 in the manner described below. Actuation of button 3022 (FIG. 30) causes server module 102 (FIG. 1) to add a new student to student administration database 502 in the manner described below. While server module 102 is serving teaching processes 402A-C, e.g., after processing according to logic flow diagram 2100 (FIG. 21), status HTML document 108 (FIG. 1) includes a button 3026 (FIG. 31). Actuation of button 3026 causes server module 102 (FIG. 1) to stop serving teaching processes 402A-C in the manner described above with respect to logic flow diagram 2200 (FIG. 22). Thereafter, server module 102 can perform the administration tasks of buttons 3018-3022 (FIG. 30) and therefore includes them in status HTML document 108 (FIG. 1).

As a result of processing by server module 102 (FIG. 1), an administrator can quickly view the status of various students using teaching processes 402A-C by reference to icons displayed in display 3002. Using status HTML document 108 (FIG. 1) and a conventional HTML viewer such as HTML viewer 106 to display status HTML document 108 and therefore the status of teaching processes 402A-C provides added flexibility. Specifically, server module 102 is, at least in part, a web server in that server module 102 receives requests for HTML documents and other types of documents in accordance with the HTTP Internet protocol and provides requested documents in response to the requests. Thus, status HTML document 108 can be viewed by generally any HTML viewer including such a viewer executing on any of student client computer systems 302A-C (FIG. 4) or remote server computer system 306. A result of this is that the local administrator can immediately observe current status of teaching processes 402A-C from any computer system coupled to local server computer system 350 through computer network 370 (FIG. 3). The local administrator can therefore observe such status from any of a number of computer systems at the local installation or can establish a dial-up connection from home to observe system status from there. In addition, technical support can more easily be provided from remote server computer system 306 by access to status HTML document 108 (FIG. 1) and viewing thereof using a conventional HTML viewer.

The full advantage of such flexibility is more completely realized by inclusion in status HTML document 108, as represented in display 3002, of buttons 3018-3022 by which an administrator can perform generally the same administration tasks which are invoked by administration module 104 as described more completely below.

On occasion, usage database 110 does not accurately represent the current status of teaching processes 402A-C, for example as a result of intermittent failures of computer network 370 (FIG. 3) such that one or more messages intended for server module 102 (FIG. 1) are lost. The inaccuracies which are most important to correct are (i) erroneous representation that a student is using a teaching process when no student is using that teaching process and (ii) erroneous representation that no student is using a teaching process when that teaching process is in fact being used by a student. If such is detected by the local administrator, the administrator is provided with mechanisms to correct such inaccuracies within usage database 110.

Server module 102 (FIG. 1) accepts requests for these corrective administrative tasks from either administrative module 104 in the form of remote procedure calling (RPC) requests or from HTML viewer 106 in the form of script instructions, e.g., data comporting with the known CGI scripting language used in conjunction with HTML documents throughout the World Wide Web. In the latter case, the script instructions are provided by host administration HTML document 112, whose content is constructed by server module 102 to provide appropriate information to the local administrator as described more completely below. An illustrative example of the display of host administration HTML document 112 by HTML viewer 106 is shown as display 3202 (FIG. 32).

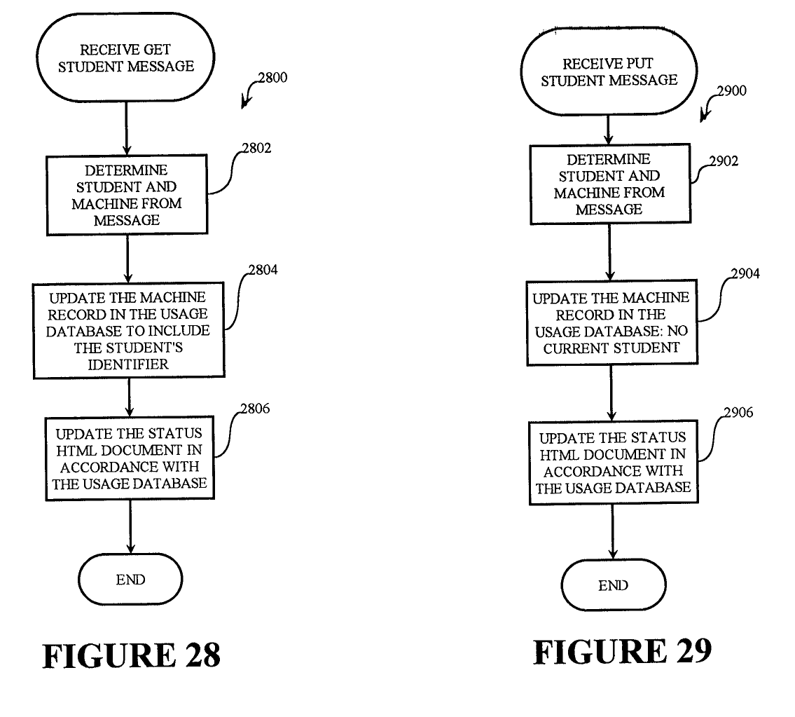

Display 3202 includes text boxes 3204 and 3206 and button 3208 by which the administrator can force server module 102 (FIG. 1) to recognize a student who is currently using a teaching process. For example, if a student is in fact using teaching process 402A while usage database 110 stores data indicating that teaching process 402A is not currently in use, the administrator can use text boxes 3204 (FIG. 32) and 3206 and button 3208 to cause server module 102 (FIG. 1) to correct usage database 110 and, accordingly, status HTML document 108 to correctly indicate that the student is using teaching process 402A. Specifically, the administrator enters alphanumeric text identifying the student into text box 3204 (FIG. 32) using conventional user interface techniques implemented by HTML viewer 106 (FIG. 1). List 3222 (FIG. 32) shows the identifiers of students authorized to use teaching processes 402A-C to aid the administrator in entering the student identifier. In addition, the administrator enters alphanumeric text identifying teaching process 402A into text box 3206 (FIG. 32) and actuates button 3208 using conventional techniques implemented by HTML viewer 106 (FIG. 1). List 3220 (FIG. 32) shows the current status of teaching processes 402A-C to aid the administrator in entering the identifier. Actuation of button 3208 (FIG. 32) executes a CGI script within host administration HTML document 112 (FIG. 1) which sends a get student message, which includes the student identifier and the teaching process identifier entered into text boxes 3202 and 3204, respectively, to server module 102. Processing by server module 102 in response to the get student message is illustrated by logic flow diagram 2800 (FIG. 28).

In step 2802, server module 102 (FIG. 1) parses from the message the student identifier and teaching process identifier.

In step 2804 (FIG. 28), server module 102 (FIG. 1) updates the one of records 208A-C (FIG. 2) which corresponds to the identified teaching process to indicate that identified student is using the identified teaching process. In this illustrative example, record 208A corresponds to the identified teaching process. Accordingly, server process 102 (FIG. 1) stores the student identifier in user field 202A (FIG. 2) of record 208A.

In step 2806 (FIG. 28), server module 102 (FIG. 1) updates status HTML document 108 to represent the current state of teaching processes 402A-C as represented in usage database 110 after step 2804 (FIG. 28). Thus, after step 2804, subsequent display of status HTML document 108 (FIG. 1) includes accurate representation that the student identified in the get student massage is using the teaching process identified in the get student message. Accordingly, the administrator forces server module 102 to correct the status of teaching processes 402A-C to accurately represent such status.

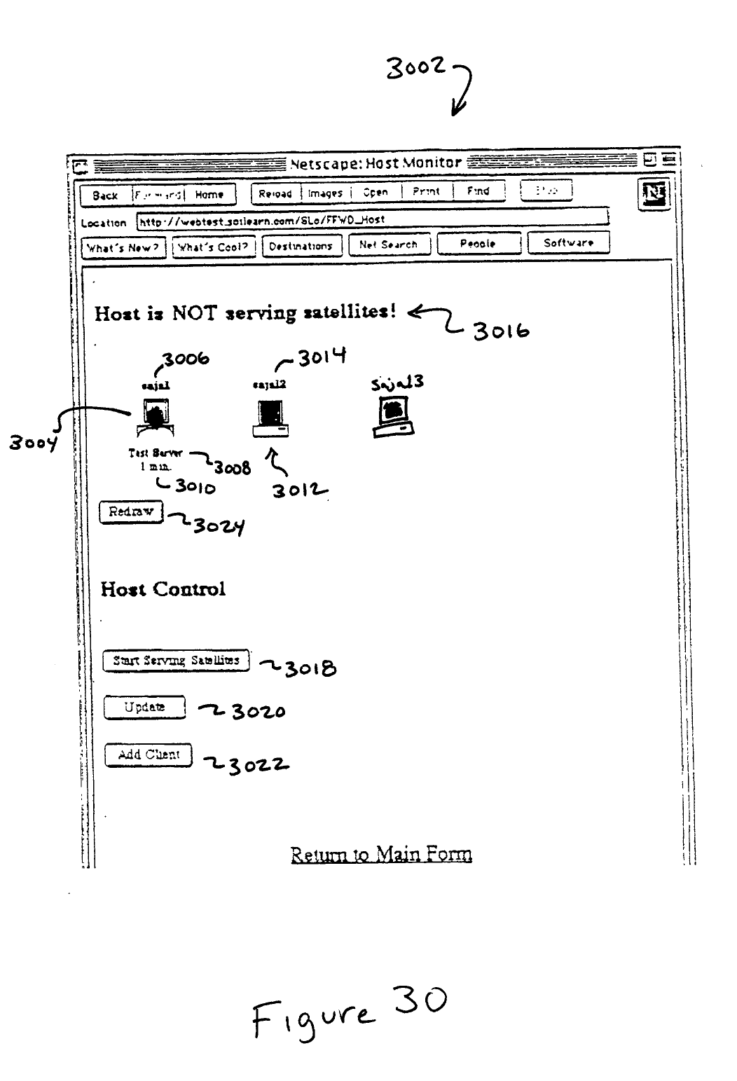

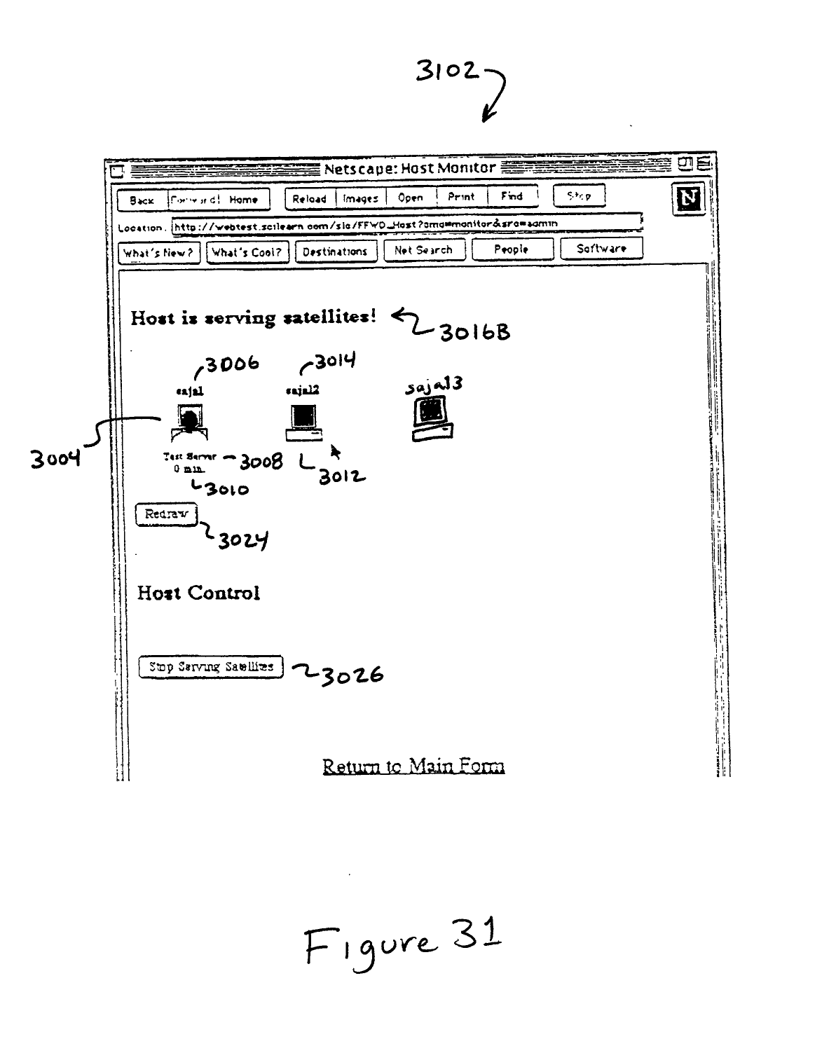

A similar mechanism allows the administrator to correct erroneous representation within status HTML document 108 of use of a particular teaching process by a student. Display 3202 includes text boxes 3210 and 3212 and button 3214 by which the administrator can force server module 102 (FIG. 1) to recognize that no student is currently using a particular teaching process. For example, if no student is in fact using teaching process 402A while usage database 110 stores data indicating that teaching process 402A is currently in use by a particular student, the administrator can use text boxes 3210 (FIG. 32) and 3212 and button 3214 to cause server module 102 (FIG. 1) to correct usage database 110 and, accordingly, status HTML document 108 to correctly indicate that no student is using teaching process 402A. Specifically, the administrator enters alphanumeric text identifying the student erroneously represented within usage database 110 as using teaching process 402A into text box 3210 (FIG. 32) using conventional user interface techniques implemented by HTML viewer 106 (FIG. 1). List 3222 (FIG. 32) shows the identifiers of students authorized to use teaching processes 402A-C to aid the administrator in entering the student identifier. In addition, the administrator enters alphanumeric text identifying teaching process 402A into text box 3212 (FIG. 32) and actuates button 3214 using conventional techniques implemented by HTML viewer 106 (FIG. 1). List 3220 (FIG. 32) shows the current status of teaching processes 402A-C to aid the administrator in entering the identifier. Actuation of button 3214 (FIG. 32) executes a CGI script within host administration HTML document 112 (FIG. 1) which sends a put student message, which includes the student identifier and the teaching process identifier entered into text boxes 3210 and 3212, respectively, to server module 102. Processing by server module 102 in response to the put student message is illustrated by logic flow diagram 2900 (FIG. 29).

In step 2902, server module 102 (FIG. 1) parses from the message the student identifier and teaching process identifier.

In step 2904 (FIG. 29), server module 102 (FIG. 1) updates the one of records 208A-C (FIG. 2) which corresponds to the identified teaching process to indicate that no student is using the identified teaching process. In this illustrative example, record 208A corresponds to the identified teaching process. Accordingly, server process 102 (FIG. 1) stores data indicating use by no student in user field 202A (FIG. 2) of record 208A.

In step 2906 (FIG. 29), server module 102 (FIG. 1) updates status HTML document 108 to represent the current state of teaching processes 402A-C as represented in usage database 110 after step 2904 (FIG. 29). Thus, after step 2904, subsequent display of status HTML document 108 (FIG. 1) includes accurate representation that no student is using the teaching process identified in the put student message and that the teaching process is now available for use by another student. Accordingly, the administrator forces server module 102 to correct the status of teaching processes 402A-C to accurately represent such status.

Since host administration HTML document 112 is in the form of an HTML document which is retrieved according to the conventional and widely used HTTP Internet protocol, host administration in the manner described above with respect to display 3202 (FIG. 32) can be accomplished through any HTML viewer which can send HTTP requests to and receive HTML documents from server module 102 (FIG. 1). For example, an administrator and access host adaptor HTML document 112 to send get and put student messages to server module 102 from local server computer system 350 (FIG. 3), remote server computer system 306, or any of student client computer systems 302A-C. Server module 108 (FIG. 1) can use any of a number of conventional authentication techniques to prevent unauthorized access to status HTML document 108 and unauthorized invocation of the administrative tasks described above. Such authentication techniques includes requiring the administrator to submit identification and password data.

One particular advantage is illustrated by the following example. Consider the hypothetical situation in which student client computer systems 302A-C and local server computer system 350 are located in a single classroom. Suppose that an administrator viewing status HTML document 108 (FIG. 1) sees a representation, e.g., within display 3102 (FIG. 31), that a particular student is using teaching process 402A (FIG. 4) of student client computer system 302A. Suppose further that the administrator can visually observe a different student sitting at and using student client computer system 302A. At this point, it is unclear whether the student has been misidentified when registering for use of teaching process 402A or the student is unable to register because a usage database 110 (FIG. 1) erroneously indicates that another student is using teaching process 402A.

To resolve the problem, the administrator simply walks over to student client computer system 302A (FIG. 3) and checks to see which of the students is registered within teaching process 402A. If the student using teaching process 402A is doing so while register as the other student, the administrator unregisters the student and re-registers the student with the proper identifier. Conversely, if the student cannot register for use of teaching process 402A since usage database 110 (FIG. 1) erroneously indicates another student is currently using teaching process 402A, the administrator uses an HTML viewer within student client computer system 302A (FIG. 4) to retrieve from server module 102 (FIG. 1) host administration HTML document 112. The administrator then forces server module 102 to correct usage database 110 using text boxes 3210-3212 (FIG. 32) and button 3214 in the manner described above. While still at student client computer system 302A (FIG. 4), the administrator can then register the student properly such that the student can commence use of teaching process 402A. As a result, the administrator can diagnose difficulties and correct any such difficulties without having to move between different computer systems.

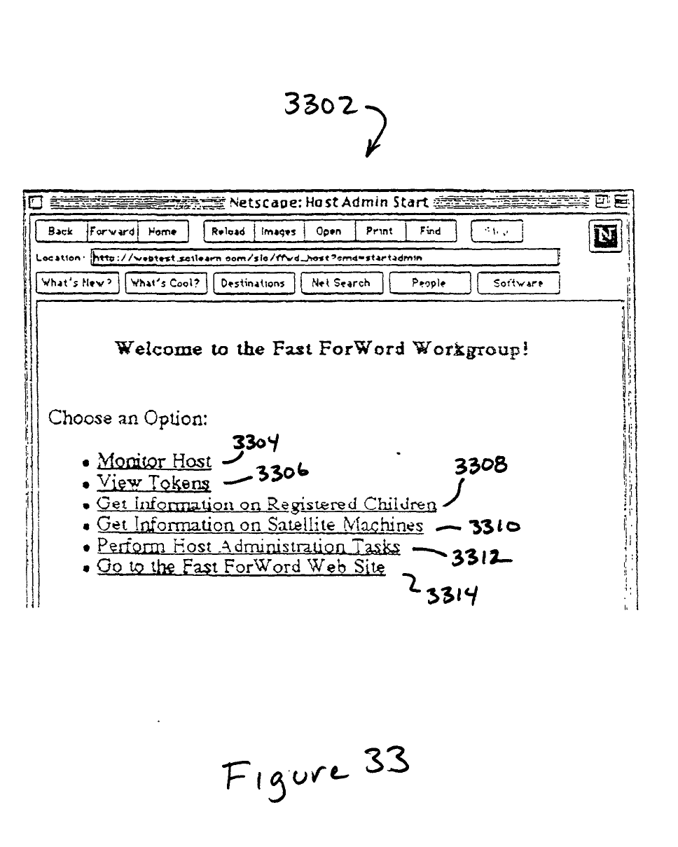

Server module 102 (FIG. 1) allows the administrator to select from host administration using host administration HTML document 112 and observing teaching process status using status HTML document 108 through a top level HTML document 114. Top level HTML document also includes links through which the administrator can perform simple, non-invasive administrative tasks. In particular, display 3302 (FIG. 33) shows the representation of top level HTML document 114 (FIG. 1) as displayed by HTML viewer 106 and includes links 3304-3314, each of which is a hypertext links which sends a message to server module 102 (FIG. 1) in the form of a universal resource locator (URL). Actuation of link 3304 (FIG. 33) by the administrator retrieves status HTML document 108 (FIG. 1) through which the administrator monitors the status of teaching processes 402A-C in the manner described above with respect to displays 3002 (FIG. 30) and 3102 (FIG. 31). Actuation of link 3314 (FIG. 33) by the administrator retrieves host administration HTML document 112 (FIG. 1) through which the administrator performs the host administration tasks described above with respect to display 3202 (FIG. 32).

Actuation of link 3306 (FIG. 33) by the administrator requests from server module 102 (FIG. 1) a list of points accumulated by all students authorized to use teaching processes 402A-C. The points are earned during use of teaching processes 402A-C in the manner described more completely below and represent a degree of progress achieved by each of the students. Server module 102 retrieves point information from student response database 404.

Actuation of link 3308 (FIG. 33) by the administrator requests from server module 102 (FIG. 1) a list of all students authorized to use teaching processes 402A-C. Server module 102 retrieves such information from configuration database 406 and displays the information in a list such as list 3222 (FIG. 32).

Actuation of link 3310 (FIG. 33) by the administrator requests from server module 102 (FIG. 1) a list of identifiers of teaching processes 402A-C. Server module 102 retrieves such information from configuration database 406 and displays the information in a list such as list 3220 (FIG. 32).

Actuation of link 3314 (FIG. 33) by the administrator requests an HTML document which describes teaching processes 402A-C in greater detail. The HTML document can be stored within any of the computer systems of FIG. 3 or can be retrieved through a wide area computer network such as the Internet.

Thus, in the manner described above with respect to status HTML document 108 and host administration HTML document 112, an administrator can access top level HTML document 114 through an HTML viewer in any computer system which is coupled through computer network 370 (FIG. 3) to server module 102 (FIG. 1).

General Interoperability of Student Client Computer Systems and Local and Remote Server Computer Systems

A student user of student client computer systems 302A-C (FIG. 4) uses any one of teaching processes 402A-C to promote development of cognitive skills of the student, and a supervisor uses a supervisor client computer system 304 to remotely monitor the progress of the student and to adjust supplementary instruction accordingly.

A computer-assisted teaching system 300 (FIG. 3) includes student client computer systems 302A-C in each of which a teaching process executes. A human student receives and responds to stimuli using user interface techniques in a manner described more completely below. Computer-assisted teaching system 300 also includes a supervisor client computer system 304 in which analysis tools can be used by a human supervisor to monitor responses of the student. A server computer system 306 compiles data representing recorded responses of the student and all other students using other student client computer systems (e.g., client computer systems 302B-C) and serves as a gateway between supervisor client computer system 304 and student client computer systems 302A-C.

Student client computer systems 302A-C (FIG. 3) are coupled to a local server computer system 350 through an intranet 370. While intranet 370 is described in this illustrative embodiment as an intranet, it is appreciated that intranet 370 can be an extranet in an alternative embodiment since an extranet is merely an intranet which permits limited external access. Remote server computer system 306 is also coupled to local server computer system 350 through intranet 370.

Server computer system 306 is coupled to, and communicates with, supervisor client computer system 304 through a computer network 310. In one embodiment, computer network 310 is the Internet. The operation of, and interaction between, remote server computer system 306, local server computer system 350, student client computer systems 302A-C, and supervisor client computer system 304 are described more completely in the context of FIG. 4.

Student client computer system 302A includes a teaching process 402A which provides a human student with stimuli and receives user-generated signals in response to the stimuli. A correct response for each stimulus is predetermined within teaching process 402A. Teaching process 402A records all received user-generated signals in a student response database 404. In addition, teaching process 402A interprets the received user-generated signals as correct or incorrect responses to stimuli and stores the interpretations of the user-generated signals in student response database 404. Incorrect responses are further categorized as misses or false alarms in this illustrative embodiment. A miss is an incorrect response by the student to a valid stimulus. A false alarm is any response by the student in the absence of a valid stimulus.

In one embodiment, a response is determined to correspond to a valid stimulus during a predetermined amount of time, e.g., one-half second, immediately following presentation of the valid stimulus to the student. For example, teaching process 402A can repeatedly play “chu” and, at some random point, play “shu” instead. In response, the student is expected to signal recognition of the transition from “chu” to “shu” using user-interface techniques. If the student fails to signal recognition of such a transition in response to playing “shu” in place of “chu” within the predetermined period of time, the student response is interpreted and recorded as a miss. If the student signals recognition of such a transition when “shu” has not been played, the student response is interpreted and recorded as a false alarm. Of course, if the student signals recognition of such a transition in response to playing “shu” in place of “chu” within the predetermined amount of time, the student response is interpreted and recorded as a hit.

As described more completely below with respect to this illustrative embodiment, stimuli and corresponding predetermined correct responses are organized into one or more modules which are called games herein, each of which has a number of categories. Each of the categories is further divided into levels. Each game is generally designed to challenge a particular cognitive skill of the student, and each category is generally designed to challenge the cognitive skill in a particular way. In addition, each level specifies generally a degree to which the cognitive skill is challenged. For example, one game challenges the student to distinguish close phonemes, a particular category challenges the student to distinguish “chu” from “shu,” and a particular level specifies the way in which “chu” and “shu” are presented to the student, e.g., (i) the speed at which “chu” and “shu” are presented, (ii) the delay between presenting each phoneme, and (iii) the degree to which “chu” and “shu” are synthesized to be more easily distinguished by a listening impaired student. Such synthesis of speech is described, for example, in co-pending U.S. patent application Ser. No. 08/______,______ filed______,______ 1997 by William M. Jenkins et al. and entitled “Method and Device for Training of Sensory Perceptual System in LLI Subjects” which is incorporated herein in its entirety by reference. In addition, the games of teaching process 402A in this illustrative embodiment are described more completely in the referenced co-pending U.S. Patent Application and that description is incorporated herein by reference.

Furthermore, student response database 404 stores data representing the pace at which the student responds to stimuli as recorded by teaching process 404. In short, student response database 404 records various types of information regarding the nature of the responses of the student to the stimuli presented to the student by teaching process 402A.

Student Response Database 404

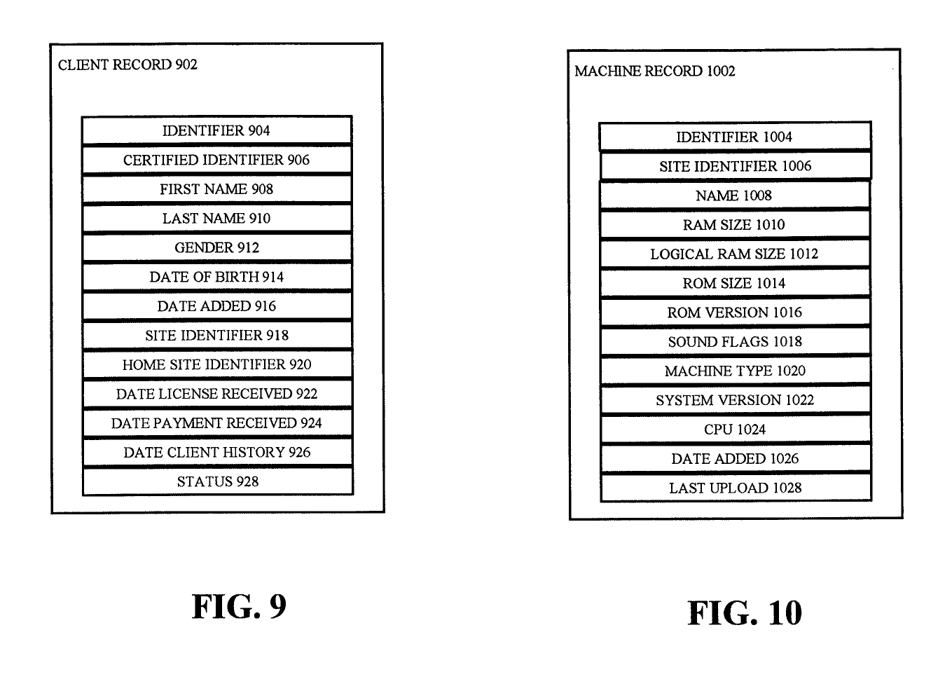

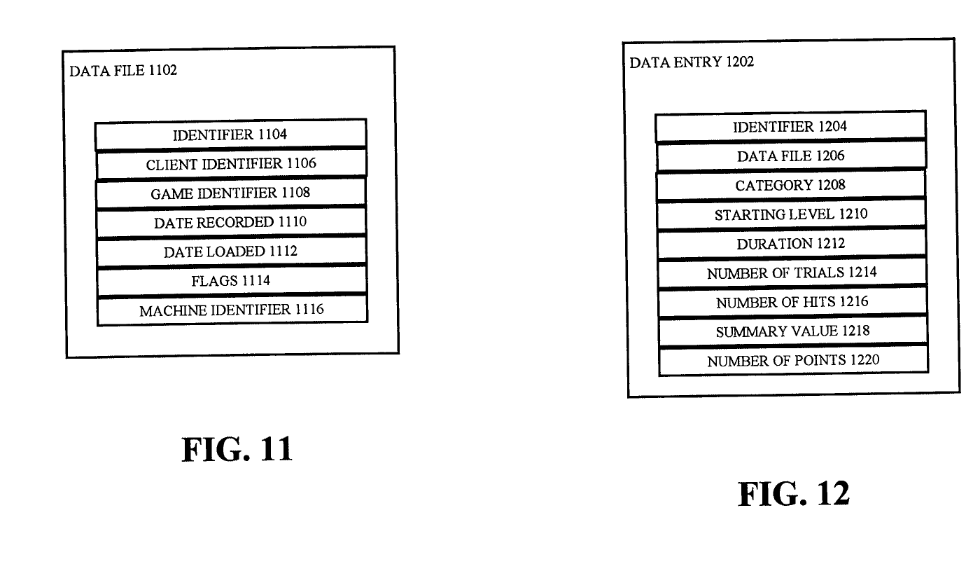

Student response database 404 includes a number of student records, e.g., client record 902 (FIG. 9), which represent individual student users of teaching processes 402A-C. In addition, student response database 404 includes data representing each of client computer systems 302A-C, e.g., machine record 1002 (FIG. 10) which represents student client computer system 302A (FIG. 4) in this illustrative embodiment. Student response database 404 includes data files and data entries, such as data file 1102 (FIG. 11) and data entry 1202 (FIG. 12), which collectively represent the responses of the subject student during execution of teaching process 402A.

Client record 902 (FIG. 9) includes a number of fields, e.g., fields 904-928, which collectively represent a student user of client computer system 302A (FIG. 4). As used herein, a field is a collection of data which represents a particular piece of information. Client record 902 (FIG. 9) includes (i) an identifier field 904, (ii) a certified identifier field 906, (iii) a first name field 908, (iv) a last name field 910, (v) a gender field 912, (vi) a day of birth field 914, (vii) a date added field 916, (viii) a site identifier field 918, (ix) a home site identifier field 920, (x) a date license received field 922, (xi) a date payment received field 924, (xii) a date client history field 926, and (xiii) a status field 928.

Identifier field 904 contains data which uniquely identifies a particular student user of client computer system 302A (FIG. 4). In the context of client record 902 (FIG. 9), the student user of client computer system 302A (FIG. 4) represented by client record 902 (FIG. 9) is referred to as the subject student. Certified identifier 906 contains data which uniquely identifies the supervisor who monitors the use of teaching processor 402A (FIG. 2) by the subject student.

Fields 908-914 (FIG. 9) represent general information about the subject student. First name field 908 and last name field 910 contain data which specify the first and last name, respectively, of the subject student. Gender field 912 contains data representing the gender of the subject student. Date of birth field 914 contains data representing that date of birth of the subject student.

Date added fielded 916 contains data representing date on which client record 902 is created. Site identifier field 918 contains data which uniquely identifies a site which includes one or more student client computer systems such as student client computer system 302A (FIG. 4). The student client computer systems of a site are administered by a single person or organization. Home site identifier field 920 (FIG. 9) contains data which represents an alternative site for the subject student, e.g., a computer system set up in the home of the subject student. The home site is considered a remote part of the site identified in site identifier field 918. Fields 922-928 store data used for financial accounting and administration of the subject student.

Machine record 1002 (FIG. 10) represents student client computer system 302A (FIG. 4) and includes fields 1004-1028 (FIG. 10). Specifically, machine record 1002 includes (i) an identifier field 1004, (ii) a site identifier field 1006, (iii) a name field 1008, (iv) a RAM size field 1010, (v) a logical RAM size field 1012, (vi) a ROM size field 1014, (vii) a ROM version field 1016, (viii) a sound flags field 1018, (ix) a machine type field 1020, (x) a system version field 1022, (xi) a CPU field 1024, (xii) a date added field 1026, and (xiii) a last uploaded field 1028.

Identifier field 1004 contains data which uniquely identifies student client computer system 302A (FIG. 3) among computer systems of computer networks 370 and 310 and other computer networks to which remote server computer system 306 is coupled. Site identifier 1006 (FIG. 10) contains data uniquely identifying a site which includes student client computer system 302A (FIG. 3) and perhaps other client computer systems. A site is generally a collection of one or more student client computer systems under the control of a single administrator. Name field 1008 (FIG. 10) contains data which identifies student client computer system 302A (FIG. 3) to student users of student client computer systems 302A-C.

Fields 1010-1024 (FIG. 10) contain data representing the specific configuration and performance characteristics of student client computer system 302A (FIG. 3). Date added field 1026 (FIG. 10) contains data representing the date on which machine record 1002 is created. Last uploaded field of 1028 contains data specifying last date and time student records of student response data base 404 (FIG. 4) and configuration data base 406 were most recently uploaded to server computer system 306.

As described above, data file 1102 (FIG. 11) represents play of a particular game of teaching process 402A (FIG. 4) by the subject student on a particular day. Data file 1102 includes (i) an identifier field 1104, (ii) a client identifier field 1106, (iii) a game identifier 1108, (iv) a date recorded field 1110, (v) a date loaded field 1112, (vi) a flags field 1114, and (vii) a machine identifier field 1116.

Identifier field 1104 contains data uniquely identifying data file 1102 among all data files stored in student response database 404 (FIG. 4). Client identifier field 1106 contains data identifying the subject student as identified by identifier field 904 (FIG. 9) of client record 902. Multiple data files such as data file 1102 (FIG. 11) can correspond to the same student and therefore contain identical data in respective instances of client identifier field 1106. Game identifier field 1108 contains data identifying a particular game to which data file 1102 pertains. Multiple data files can correspond to the same game. In the context of data file 1102, the game identified by game identifier field 1108 is referred to herein as the subject game.

Date recorded field 1110 contains data which specifies the date on which the subject student played the game as recorded in data file 1102. Date loaded field 1112 contains data which specifies the date on which data file 1102 is created and entered into student response database 404 (FIG. 4). Flags field 1114 (FIG. 11) contains a number of flags, each of which has one of two possible values. The flags of flags field 114 specify which types of data are represented in data entries, e.g., data entry 1202 (FIG. 12), associated with data file 1102 (FIG. 11). Such types include hits, misses, false alarms, and reaction times, for example. Machine identifier field 11 16 contains data representing the particular computer system on which the subject user plays the subject game as represented by data file 1102. In this illustrative example, machine identifier field 1116 identifies student client computer system 302A (FIG. 4).

Each category of a play session in which the subject student plays the subject game is represented by a respective data entry such as data entry 1202 (FIG. 12). Data entry 1202 includes a number of fields, namely, (i) an identifier field 1204, (ii) a data file field 1206, (iii) a category field 1208, (iv) a starting level field 1210, (v) a duration field 1212, (vi) a number of trials field 1214, (vii) a number of hits field 1216, (viii) a summary value field 1218, and (ix) a number of points field 1220.

Identifier field 1204 contains data uniquely identifying data entry 1202 from all other data entries stored in student response database 204 (FIG. 2). Data file field 1206 (FIG. 12) contains data identifying data file 1102 (FIG. 11) as the data file to which data entry 1202 (FIG. 12) pertains. The identifying data stored in data file field 1206 corresponds to identifying data stored in identifier field 1104 (FIG. 11) of data file 1102.

Category field 1208 (FIG. 12) contains data identifying the category of the subject game to which data entry 1202 pertains. In the context of data entry 1202, the category identified by category field 1208 is called the subject category. Starting level field 1210 contains data specifying the level of the subject category at which the subject student started the session represented by data entry 1202, which is referred to as the subject session in the context of data entry 1202. Duration field 1212 contains data specifying the amount of time during which the subject student played the subject category. Number of trials field 1214 contains data representing the number of time the subject student was presented with stimuli in the subject category. Number of hits field 1216 contains data representing the number of time the subject student responded correctly to presented stimuli during the subject category. Summary value field 1218 contains data which encapsulates performance by the student thus far in the current play of the subject category. Number of points field 1220 contains data representing a number of game rewards acquired by the subject student during play of the subject category. In one embodiment, the game rewards serve as motivation for students playing the games and are currency in a token economy.

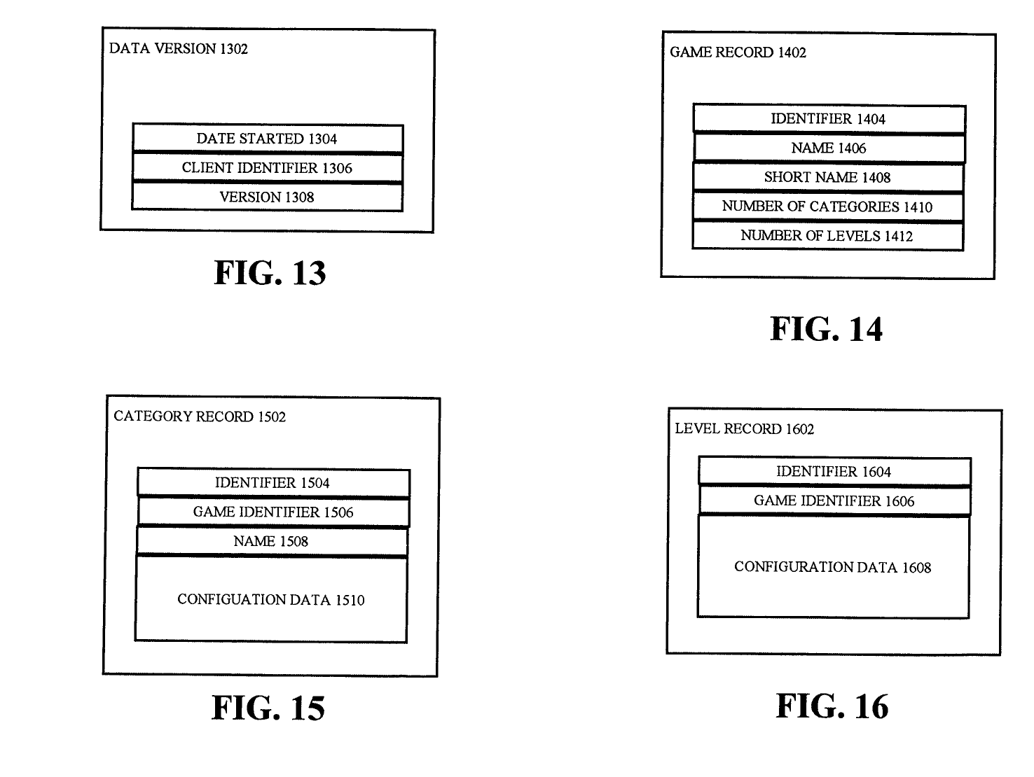

Student response database 204 also includes a number of data version records such as data version 1302 (FIG. 13), each of which represents the version of each software component of the games played by the subject student. In the context of data version 1302, the subject version is the version represented by data version 1302. Data version 1302 includes a date started field 1304, a client identifier 1306, and a version field 1308. Date started field 1304 contains data specifying the date on which the subject student started using the subject version. Client identifier field 1306 contains data identifying the subject student. Version field 1308 contains data identifying the subject version.

Thus, student response database 404 (FIG. 4) includes data representing responses of one or more students to stimuli presented by teaching process 402A. As described more completely below, such data can be used remotely by a supervisor to monitor and evaluate the development of cognitive skill by the students.

As described more completely below, student response data for all students which use teaching processes such as teaching process 402A are stored in a global student database 412. Furthermore, the student response data stored in global student database 412 is accessible by supervisors who monitor a student's progress in developing cognitive skills through teaching process 402A, for example. Therefore, teaching process manager 108 periodically uploads student response data from student response database 404 to server process 410 for storage in global student database 412. In one embodiment, such uploading takes place in response to a request by the student, or by a system administrator managing use of student client computer system 302A by the student, using graphical user interface techniques, that student response data pertaining to the student is uploaded. Since network 310 (FIG. 3) can be slow and/or busy, allowing the user to determine a desirable time to perform a potentially lengthy upload of student response data avoids annoying and inconvenient delays in the execution of teaching process 402A.

When teaching process manager 108 uploads student response data for a particular student, e.g., the subject student, teaching process manager 108 retrieves the data from student response database 404 and packages the data for transport through computer network 310 (FIG. 3). Specifically, teaching process manager 108 (FIG. 4) retrieves from student response database 404 client record 902 (FIG. 9) along with each data file (e.g., data file 1102—FIG. 11), data entry (e.g., data entry 1202—FIG. 12), and data version (e.g., data version 1302—FIG. 13) which correspond to client record 902 (FIG. 9). Teaching process manager 108 (FIG. 2) determines which data files correspond to client record 902 (FIG. 9) by reference to data stored in client identifier field 1106 (FIG. 11) of each data file. Teaching process manager 108 (FIG. 4) determines which data entries correspond to client record 902 (FIG. 9) by reference to data stored in data file identifier field 1206 (FIG. 12) of each data entry. If data stored in data file identifier field 1204 identifies a data file which in turn contains data in client identifier field 1106 (FIG. 11) which identifies client record 902 (FIG. 9), then data entry 1202 (FIG. 12) corresponds to client record 902 (FIG. 9). Teaching process manager 108 (FIG. 4) determines which data versions correspond to client record 902 (FIG. 9) by reference to data stored in client identifier field 1306 (FIG. 13) of each data version.

Teaching process manager 108 (FIG. 4) forms a consolidated representation of the retrieved records, files, entries, and versions. Such a consolidated representation is complete and self-contained, i.e., does not require extrinsic information to resolve references between items. Such is true since each item includes a field which specifies the item's identifier. For example, client record 902 (FIG. 9) includes identifier field 904 which contains the identifier of client record 902, and that identifier is used by data file 1102 (FIG. 11) and data version 1302 (FIG. 13) to identify client record 902 (FIG. 9). Similarly, data file 1102 (FIG. 11) stores its own identifier in identifier field 1104; and data entry 1202 (FIG. 12) stores its own identifier in identifier field 1204. Accordingly, client record 902 (FIG. 9), data file 1102 (FIG. 11), data entry 1202 (FIG. 12), and data version 1302 (FIG. 13) can be removed from the particular address space and execution state of student client computer system 302A (FIG. 4) and still be fully specified with all references fully resolved and unaffected by transportation to server computer system 306.

Upon receipt by server process 410, server process 410 stores data from the consolidated representation in global student database 412. Global student database 412 includes the data from the consolidated representation in a relational database having the structure described above with respect to FIGS. 9-16 and further includes flat files which store redundant information from the consolidated representation. In one embodiment, the flat files are disk files which store records such as those shown in FIGS. 9-16 in the form of lines of ASCII text. Since the flat files are ASCII text data files in this illustrative embodiment, transportation of the flat files through computer network 310 can be accomplished by any of a number of well-known and conventional mechanisms including, for example, the known and conventional file transfer protocol (FTP).

To facilitate accurate analysis of student response data in the manner described below, frequent uploading of student response data is encouraged. In one embodiment, student response database 404 has sufficient space allocated for response data for a single student for a limited number of days, e.g., five days. When a student has not uploaded in the last five days during which any of teaching processes 402A-C was used by the student, storage of further student response data in student response database 404 fails and any of teaching processes 402A-C refuse to execute normally until the student uploads student response data from previous sessions with teaching processes 402A-C. When the student uploads the student response data from student response database 404, student response database 404 frees space for additional student response data for the student.

In one illustrative embodiment, the space is limited by storing each day's activity by a particular student as a flat file which is one of only five disk files with predetermined names used in a round-robin manner. As each flat file is uploaded to server computer system 306 (FIG. 3), the flat file is deleted from student client computer system 302A. At the start of each day's use of teaching process 402 (FIG. 4) by the student, a new flat file is created to store the response data corresponding to the student's use of teaching process 402A for that day. The new flat file has a predetermined file name according to the round robin scheme described above. If the predetermined file name is already in use, then all five predetermined file names are in use and the student is required to upload all five flat files before continuing with use of teaching process 402A.

Configuration Database 406

As described above, configuration database 406 stores data which specifies components of the behavior of teaching processes 402A-C. Specifically, configuration database 406 includes game records, e.g., game record 1402 (FIG. 14), representing specific games of teaching processes 402A-C (FIG. 4) and category records, e.g., category record 1502 (FIG. 15), representing specific categories of each game of teaching processes 402A-C (FIG. 4).

Game record 1402 (FIG. 14) includes an identifier field 1404, a name field 1406, a short name field 1408, a number of categories field 1410, and a number of levels field 1412. Identifier field 1404 contains data which uniquely identifies the game represented by game record 1402 which is referred to herein as the subject game. Name field 1406 and short name field 1408 contain data which specify respective alternative identifying names of the subject game which are generally more suitable for representation to a user than is the identifying data stored in identification field 1404. Number of categories field 1410 contains data specifying the number of categories of the subject game. Number of levels field 1412 contains data specifying the number of levels of the subject game.

Category record 1502 (FIG. 15) represents specific behavior characteristics of the subject game of teaching process 402A-C (FIG. 4) for a particular category and includes an identifier field 1504, a game identifier field 1506, a name field 1508, and a configuration data field 1510. Identifier field 1504 contains data which uniquely identifies the category represented by category record 1502 which is referred to herein as the subject category. Game identifier field 1506 contains data identifying the subject game as the game to which the subject category pertains. Name field 1508 contains data which specifies an identifying name of the subject category which is generally more suitable for representation to a user than is the identifying data stored in identification field 1504. Configuration data field 1510 contains data specifying the particular behavior of the subject category of the subject game within teaching processes 402A-C (FIG. 4). The specific form and effect of configuration data stored in configuration data field 1510 is specific to the subject game. For example, if the subject game tests the student's ability to recognize specific sonic tones, the configuration data can specify the frequency and duration of the tone. Thus, each category of the subject game corresponds to a different tone which the student is to recognize.

Level record 1602 (FIG. 16) represents a specific level of difficulty for the subject game and includes an identification field 1604, a game identifier field 1606, and a configuration data field 1508. Identifier field 1604 contains data which uniquely identifies the level represented by level record 1602 which is referred to herein as the subject level. Game identifier field 1606 contains data identifying the subject game as the game to which the subject level pertains. Configuration data field 1608 contains data specifying the particular behavior of the subject level of the subject game within teaching process 402A-C (FIG. 4). The specific form and effect of configuration data stored in configuration data field 1510 is specific to the subject game. For example, in the illustrative example in which the subject game tests the student's ability to recognize specific sonic tones, the configuration data can specify an inter-stimulus interval (ISI). The ISI is the amount of time which is allowed to elapse between presentation of distinct stimuli to the student. Higher levels of the subject game typically have lower ISIs since the higher levels correspond to better cognitive abilities of the student. Thus, each level of the subject game corresponds to a different level of cognitive ability of the student.

Adaptation of Teaching Processes 402A-C

Teaching processes 402A-C are adaptive in that teaching processes 402A-C change their own behavior in response to the nature of the students responses as represented in student response data 404. For example, if the student consistently achieves a predetermined level of proficiency in responding to stimuli of a particular game at a particular level for a particular category of the game, teaching process 402A increases the level, and therefore the level of difficulty, of the category. Specifically, teaching process 402A stores in student response database 404 a data entry, e.g., data entry 1202, for the student and stores in category field 1208 data identifying the category and stores in starting level 1210 data representing a higher level for which the student has not yet achieved the predetermined level of proficiency. In one embodiment, the predetermined level of proficiency is the level at which the student's responses match the predetermined correct responses for 80% of the stimuli presented to the student. The number of matching responses for the student for a particular level of a particular category is represented in number of hits field 1216. The number of stimuli presented to the student for the level of the category is represented in number of trials field 1214. In other embodiments, the level of proficiency can include consideration of other parameters of the responses of the student, including without limitation time for response to the stimuli and the number of false alarms.

In another, alternative embodiment, a three-up-one-down mechanism is used to adjust the level of difficulty of teaching process 402A to the cognitive ability of the student. Specifically, the level of difficulty is increased each time the student responds correctly to three consecutive stimuli and is decreased each time the student responds incorrectly to any stimulus. To avoid frustrating the student, teaching process 402A (FIG. 4) changes to a different game when the level of difficulty decreases a predetermined number of times during a single session of use of teaching process 402A, e.g., eight times. A level record, e.g., level record 1602 (FIG. 16) records the highest level achieved by the student. When starting a new session of use of teaching process 402A (FIG. 4), for example on the next day, play of the same game begins several levels of difficulty below the highest level achieved previously to reinforce the cognitive skills of the student.

Teaching processes 402A-C are analogous to one another and the preceding and following descriptions of teaching process 402A is equally applicable to teaching processes 402B-C. Thus, as the student achieves new levels of proficiency, representing increased cognitive ability of the student, the behavior of teaching processes 402A-C adapt to further challenge the increased cognitive ability.

Local adaptation of teaching processes 402A-C, i.e., adaptation by teaching processes 402A-C in response to responses of the student by use of student client computer systems 302A-C, allows teaching processes 402A-C to adapt immediately to the particular needs and abilities of the student within a single execution of teaching processes 402A-C. However, teaching processes 402A-C also provide benefits from global adaptation. In global adaptation, a server process 410 monitors responses of student users of student client computer systems 302A-C (FIG. 3) and sends student client computer system 302A-C configuration data which adapts teaching processes 402A-C (FIG. 4) to better serve and adapt to the particular needs and abilities of the student.

To enable global adaptation of teaching processes 402A-C, local server computer system 350 includes a teaching process manager 108 which accesses data stored in configuration database 406 and student response database 404 on behalf of server process 410. Specifically, teaching process manager 108 retrieves data from student response database 404 and from configuration database 406 and sends that data to server process 410 for storage in a global student database 412. In an alternative embodiment, the uploading of student response data and configuration data from student response database 404 and configuration database 406, respectively, is initiated by a local administrator through administration module 104 which sends a request message to server module 102 to upload such data. In either case, server module 102 receives a request for such data in the form of a HTTP transfer request.

Accordingly, global student database 412 stores, for each student user of computer-assisted teaching system 300 (FIG. 3), a record of all student response data and all configuration data. Thus, global student database 412 contains information regarding the use of teaching processes 402A-C by a student user and the manner in which teaching processes 402A-C have thus far adapted to the student's responses. Global student database 412 includes records and entries generally of the structure described above with respect to FIGS. 11-16.

In addition, teaching process manager 108 can receive configuration data from server process 410 for storage in configuration database 406. Such configuration data can include various flags and/or conditional variable settings to change the behavior of teaching processes 402A-C in ways anticipated by component computer instructions of teaching processes 402A-C. Such configuration data can be, for example, configuration stored in configuration data field 1510 (FIG. 15) of category record 1502 and/or in configuration data field 1608 (FIG. 16) of level record 1602 to alter the behavior of teaching processes 402A-C during play of the subject game within the subject category at the subject level.

In one embodiment, such configuration signals can also include computer instruction modules to replace or augment component computer instructions of teaching processes 402A-C to change the behavior of teaching processes 402A-C in ways not anticipated by the component computer instructions of teaching processes 402A-C. Specifically, teaching process manager 108 requests such computer instruction modules from server process 410 each time teaching process manager 108 sends data from student response database 404 to server process 410 for inclusion in global student database 412. Accordingly, teaching process manager 108 obviates re-establishment of the communication channel between teaching manager 108 and server process 410 already established for sending the student response data. The request can include data specifying the most recent versions of various components of teaching processes 402A-C. Server process 410 responds by (i) sending data indicating no new computer instruction modules are needed or (ii) sending the computer instruction modules. Teaching process manager 108 includes any received computer instruction modules into teaching processes 402A-C, superseding any previously included corresponding computer instruction modules. As a result, teaching process manager 108 enables server process 410 to change the behavior of teaching processes 402A-C.

A human supervisor using supervisor client computer system 304 can monitor interaction between various students and student client computer systems 302A-C regardless of geographical distances between the supervisor and the students. For example, a clinical psychologist can remotely monitor a student's progress by retrieving data from global student database 412. It is anticipated that use of teaching processes 402A-C will typically be accompanied by direct consultation between the student and the supervisor periodically to augment the training and improved cognitive ability provided by teaching processes 402A-C. The supervisor can use student response data retrieved from global student database 412 to tailor such direct consultation to thereby maximize future progress of the student.

Supervisor client computer system 304 includes a student data fetcher 420 which retrieves from global student database 410 records for one or more students specified by the supervisor using graphical user interface techniques. Student data fetcher 420 forwards the received records to analysis tools 422 which are all or part of one or more computer processes executing within supervisor client computer system 304.

Analysis tools 422 provide the supervisor with a user interface by which the supervisor can request information regarding the progress of one or more specific students and can request that the information be processed and represented in a form in which the supervisor can properly analyze the progress of the specified students. Analysis tools 422 provide the supervisor with a wide variety of information presentation formats and statistical analysis tools such that the supervisor can determine the particular form in which the data is represented to best illuminate aspects of the responses of the specified students which the supervisor wishes to review and analyze.

Analysis tools 422 can display various types of reports for the supervisor. Such types include schedule reports, summary reports, history reports, assessment results reports, word game summary reports, and sound game summary reports.

Schedule reports display, in graphical form and/or in tabular textual form, data describing the dates and durations of sessions of a particular student with teaching processes 402A-C. In general, the supervisor specifies a particular student and a range of dates using graphical user interface techniques. Analysis tools 422 represent in report form the dates and durations of sessions by the specified student during the specified range of dates. Through such schedule reports, the supervisor can verify that the specified student is using teaching processes 402A-C as much as prescribed and is therefore likely to obtain the full benefit in terms of improved cognitive ability as a result. Conversely, the supervisor can determine from such schedule reports that a particular student is failing to keep up with the prescribed schedule of use of teaching processes 402A-C and is therefore less likely to benefit therefore. In the latter case, the supervisor can determine through direct consultation with the student the specific cause for failure of the student to maintain the prescribed schedule.

Summary reports display a summary of the performance of a particular student in the use of teaching processes 402A-C in each category of each of the games. The summary of the performance of the student in a summary report provides the supervisor with a general indication of the progress made by the student without the detail provided by a history report as described below.

History reports display, in a graphical and/or tabular textual form, a complete history of a particular student's use of teaching processes 402A-C. History reports generally include all the information of a schedule report in combination with specific response data of the student. Such response data includes the specific stimuli presented to the student on each date on which the student used teaching processes 402A-C and the corresponding response of the student. A history report gives the supervisor the entirety of the student's experience with teaching processes 402A-C and enables the supervisor to perceive trends and changes in the cognitive ability of the student.

History reports can also be sorted by category and level. Therefore, responses of a particular student to various stimuli within a particular category or at a particular level can be more closely examined by the supervisor to detect trends in the cognitive ability of the student with specific stimuli, e.g., specific phonemes and/or specific grammatical constructs.

Assessment results reports display information pertaining to a particular student's performance during use of an assessment tool within teaching processes 402A-C. Teaching processes 402A-C each include a number of assessment tools, one for each category of each game in one embodiment, which closely resemble categories of the games of teaching processes 402A-C. The student plays an assessment tool to establish a level of cognitive ability. By comparison, the games of teaching processes 402A-C are designed to train, i.e., to improve the cognitive abilities of, the student. The student is typically required to play one or more assessment tools prior to beginning, and upon completion of, a course of training. In addition, a student can be asked to play one or more assessment tools periodically during the course of training. Through assessment results reports, the supervisor can measure the change in cognitive ability realized through the course of training.

Word game summary reports display for the supervisor word sentences used as stimuli to a particular student in a particular game. The supervisor selects the student and the game using graphical user interface techniques. In addition, the supervisor specifies whether the supervisor desires to see all sentences used as stimuli to the student in the game or to see only sentences for which the student responded incorrectly. Through a word game summary report, the supervisor can determine to which sentences the student has been exposed and which of those sentences are difficult for the student to understand.

Sound game summary reports display for the supervisor sounds, e.g., phonemes and frequency sweeps, used as stimuli to a particular student in a particular game. The sound game summary reports further display the student's progress in responding to the stimuli during a range of dates specified by the supervisor. The supervisor selects the student, the game, and the range of dates using graphical user interface techniques. Through a sound game summary report, the supervisor can determine to which sound stimuli the student has been exposed and which of those sound stimuli are difficult for the student to hear and identify.

The result of analysis by the supervisor of the student response data retrieved from global student database 412 is an opinion of the supervisor with respect to a course of action to maximize the progress of the student in the particular aptitudes exercised and enhanced by teaching processes 402A-C. Such a course of action can include (i) adaptation of the behavior of teaching processes 402A-C to the particular needs and abilities of the student and/or (ii) independent consultation of the student.

As an example of the latter, the supervisor can determine that the student doesn't fully understand negation (e.g., responds incorrectly to the stimulus, “Point to the boy that is not smiling.”) and can initiate independent consultation which focuses on improving the student's understanding of negation. Such independent consultation can include conventional tutoring and remediation.

With respect to adaptation of the behavior of teaching processes 402A-C, the supervisor can specify through prescription module a new starting level as represented in starting level 1201 (FIG. 12) of a particular category of a particular game. In this way, the supervisor can configure teaching processes 402A-C (FIG. 4) to regress to a lower level of a particular category of a particular game to allow a student to exercise cognitive skills which are developing more slowly than anticipated or to skip ahead to a higher level of a particular category of a particular game to keep the student challenged in areas where the student has better cognitive skills. The supervisor can prescribe such adaptation through prescription module 424 which is all or part of a computer process executing within supervisor client computer system 304.

Prescription module 424 includes a user interface by which the supervisor can specify adaptations in the behavior of teaching processes 402A-C. Prescription module 424 represents the behavioral adaptations specified by the supervisor as configuration data which are forwarded to configuration module 426. When the supervisor has finished specifying changes in the behavior of teaching processes 402A-C, the supervisor issues, using graphical user interface techniques, a command to prescription module 424 to transfer the newly created configuration data from configuration module 426 to global student database 410 for subsequent inclusion in configuration database 406. In response thereto, prescription module 424 sends instructions to configuration module 426 which cause configuration module 426 to send the configuration data stored in configuration module 426 to server process 410 for storage in global student database 412.

Server process 410 receives the configuration data from configuration module 426 within supervisor client computer system 304 and incorporates the configuration data into the appropriate student record within global student database 412. The appropriate student record is identified by data which configuration module 426 includes in the configuration data and which identifies the student to which the changes in behavior are prescribed by the supervisor.

Server process 410 updates configuration database 406 to include the configuration data received from configuration module 426. Accordingly, teaching processes 402A-C subsequently exhibit the changes in behavior represented in the configuration data prepared by the supervisor through use of prescription module 424 in the manner described above. Server process 410 updates configuration database 406 by sending the configuration data to teaching process manager 108 along with instructions directing teaching process manager 108 to include the configuration data in configuration database 406. In one embodiment, server process 410 updates configuration database 406 substantially immediately after receiving the configuration data from configuration module 426. In an alternative embodiment, server process 410 stores data in the appropriate student record of global student database 412 indicating that configuration database 406 requires updating to include the configuration data and updates configuration database 406 at a later time. Such a later time can be a regular daily update time, e.g., during off-peak time when use of student client computer system 302 is unlikely, or when student client computer system 302 indicates to server process 410 that a new session in which a student uses any of teaching processes 402A-C is about to begin in a registration of the student. Registration of students is described below in greater detail.

Thus, the supervisor (i) reviews specific aspects of the student's use of teaching processes 402A-C through student response data displayed by analysis tools 422 and (ii) prescribes and effects specific changes in the behavior of teaching processes 402A-C to more effectively promote development of the student. Since student client computer systems 302A-C and supervisor client computer system 304 can be geographically dispersed, the supervisor can supervise the progress of multiple students notwithstanding such geographical separation.

With respect to global adaptation of teaching processes 402A-C, server computer system 306 includes analysis tools 414 and a reconfiguration module 416. Analysis tools 414 retrieve student records from global student database 412 and compiles statistical information regarding data received from student response database 404 and configuration database 406. Analysis tools 414 can present the compiled information to a human evaluator for analysis and reconfiguration recommendations in the manner described above with respect to analysis tools 422 or, alternatively, can process the compiled information to automatically formulate reconfiguration recommendations using artificial intelligence and expert systems techniques. For example, analysis tools 414 can provide information regarding specific stimuli of teaching processes 402A-C which elicit incorrect responses in a disproportionate number of cases, suggesting that the specific stimuli are perhaps too challenging for a particular level of a particular category.

Reconfiguration module 416 produces configuration data which causes changes in the behavior of teaching processes 402A-C. For example, reconfiguration module 416 can modify data stored in configuration data fields 1510 (FIG. 15) and/or 1608 (FIG. 16) to effect such changes in behavior of teaching processes 402A-C (FIG. 4). In one embodiment, reconfiguration module 416 is responsive to user-generated signals received in response to a human evaluator using graphical user interface techniques in the manner described above with respect to prescription module 424. In an alternative embodiment, reconfiguration module 416 receives statistical information from analysis tools 414 and forms reconfiguration signals using artificial intelligence and/or expert systems techniques. For example, such reconfiguration signals can modify stimuli which elicit incorrect student responses a disproportionate number of times to present a more appropriate level of challenge for the particular level of the particular category.

Administration of Student Users

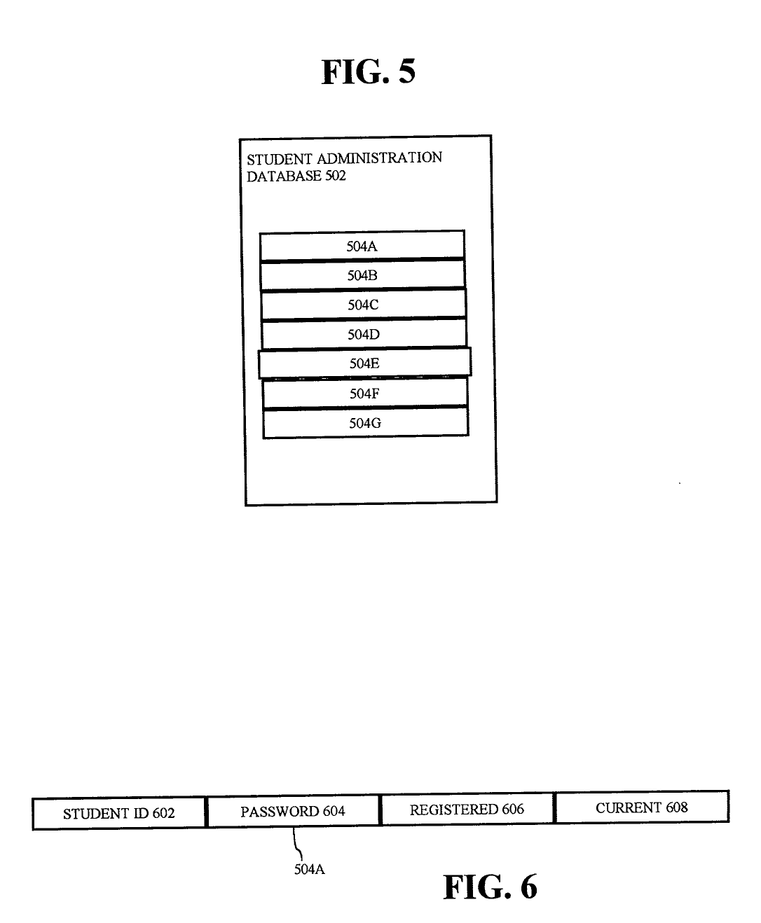

Teaching process manager 108 performs administration tasks in managing use of student client computer systems 302A-C by a number of students. Teaching process manager 108 includes a student administration database 502 which in turn includes student administration records 504A-G (FIG. 5). Each of student administration records 504A-G represents the status of a respective student authorized to use any of teaching processes 402A-C. Student administration records 504A-G are analogous to one another, and the following description of student administration record 504A is equally applicable to each of student administration records 504B-G.

Student administration record 504A is shown in greater detail in FIG. 6 and includes a student identification field 602, a password field 604, a registered flag 606, and a current flag 608. Each of fields 602-608 stores data representing a component of the administrative state of the student represented by student administration record 504A. Student identification field 602 stores data uniquely identifying the student among all students authorized to use teaching processes 402A-C (FIG. 4). For example, the data can be alphanumeric data representing the student's name or the student's social security number. The student identification data stored in student identification field 602 is identical to the student identification data stored in identifier field 904 (FIG. 9) of client record 902 and identifies the subject student.

Password field 604 (FIG. 6) stores data representing a password by which the subject student is authenticated. Password field 604 can contain predetermined data which indicates no password is required for authentication or can be omitted altogether. The necessity for a password for student authentication is determined by a human administrator through a user interface of teaching process manager 108 (FIG. 4). Such a human administrator preferably knows who has physical access to student client computer systems 302A-C and can therefore determine whether password-based student authentication is required.

Registered flag 606 (FIG. 6) stores data having a boolean value and indicating whether the subject student is currently using one of teaching processes 402A-C (FIG. 4). Current flag 608 (FIG. 6) stores data having a boolean value and indicating whether student response data stored in student response database 404 (FIG. 4) and configuration data stored in configuration database 406 for the subject student has been uploaded to global student database 412.

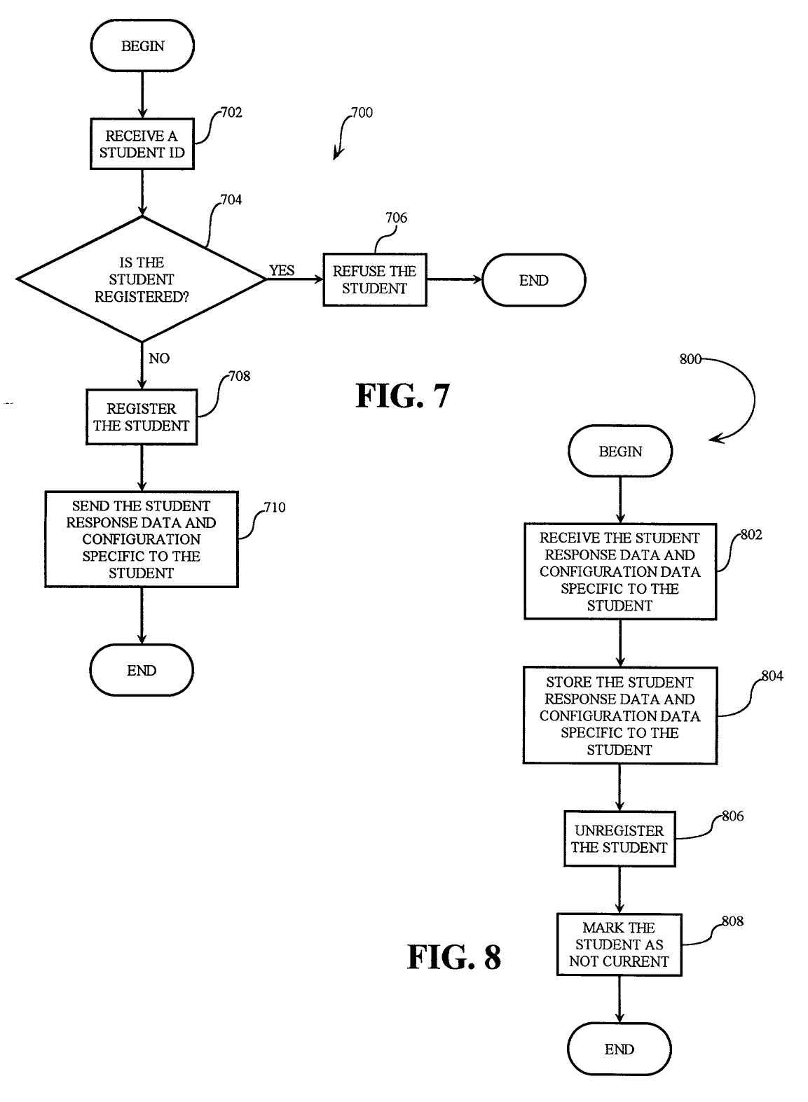

To use teaching process 402A, a student (or an administrator assisting the student) causes teaching process 402A to send to teaching process manager 108 data identifying the student. In one embodiment, the data is entered directly by the student using user interface techniques. In an alternative embodiment, teaching process 420 requests and receives from teaching process manager 108 identifying data for each student authorized to use teaching processes 402A-C as represented in student identification field 602 (FIG. 6) of student administration record 504A and analogous student identification fields in student administration records 504B-G. In this alternative embodiment, the student selects the student's identifier from the list using graphical user interface techniques. Teaching process manager 108 receives the student identification data and grants or denies the student access to teaching process 402A according to logic flow diagram 700 (FIG. 7).

Processing according to logic flow diagram 700 begins in step 702 in which teaching process manager 108 (FIG. 4) receives the student identifying data. In this illustrative example, the received student identification data identifies the subject student, i.e., the student represented by student administration record 504A (FIG. 5). Processing transfers to test step 704 (FIG. 7) in which teaching process manager 108 (FIG. 4) determines whether the identified student is registered. Teaching process manager 108 makes such a determination by retrieving from student administration database 502 (FIG. 5) the one of student administration records 504A-G whose student identification field matches the received student identification data, i.e., retrieving student administration record 504A, and retrieves from that student administration record data stored in registered flag 606 (FIG. 6). Teaching process manager 108 (FIG. 4) compares the data retrieved from registered flag 606 (FIG. 6) to data indicating that the subject student is registered, i.e., is currently using one of teaching processes 402A-C (FIG. 4).

If the subject student is registered, processing by teaching process manager 108 transfers to step 706 (FIG. 7) in which teaching process manager 108 (FIG. 4) refuses the student access to teaching process 402A. Accordingly, the student is not permitted to use more than one of teaching processes 402A-C at any one time. After step 706 (FIG. 7), processing according to logic flow diagram 700 terminates.

Conversely, if the subject student is not registered, use of teaching process 402A (FIG. 4) by the subject student is permitted and processing transfers to step 708 (FIG. 7). In step 708, teaching process manager 108 (FIG. 4) registers the student by storing data in registered flag 606 (FIG. 6) data so indicating. Processing transfers to step 710 (FIG. 7) in which teaching process manager 108 (FIG. 4) sends to teaching process 402A student response data for the subject student previously stored in student response database 404 and configuration data for the subject student previously stored in configuration database 406. After step 710 (FIG. 7), processing according to logic flow diagram 700 terminates and the student is permitted to use teaching process 402A (FIG. 4). Since teaching process 402A has received student response data and configuration data specific to the subject student, teaching process 402A retains all previous adaptations of teaching process 402A-C specific to the subject student. In an analogous manner, any adaptations of teaching process 402A during the current use of teaching process 402A by the subject student as represented in student response data and/or configuration data are retained during subsequent uses of any of teaching processes 402A-C.

When the subject student has completed use of teaching process 402A, teaching process 402A sends student response data and configuration data specific to the subject student to teaching process manager 108 for inclusion in student response database 404 and configuration database 406, respectively. Processing by teaching process manager 108 in response to receipt of such student response data and configuration data is shown as logic flow diagram 800 (FIG. 8) in which processing begins with step 802.

In step 802, teaching process manager 108 (FIG. 4) receives the student response data and configuration data specific to the subject student. In step 804 (FIG. 8), teaching process manager 108 (FIG. 4) stores the student response data and configuration data in student response database 404 and configuration database 406, respectively. Processing transfers to step 806 (FIG. 8) in which teaching process manager 108 FIG. 4) un-registers the subject student by storing in registered flag 606 (FIG. 6) data indicating that the subject student is not currently using any of teaching processes 402A-C (FIG. 4). In step 808 (FIG. 8), to which processing transfers from step 806, teaching process manager 108 (FIG. 4) marks the subject student as not current. Specifically, teaching process manager 108 stores in current flag 608 (FIG. 6) data indicating that the student response data and configuration data specific to the subject student may have changed since such data was last uploaded to global student database 412 (FIG. 4). Alternatively, teaching process manager 108 can immediately upload such student response data and configuration data to global student database 412. However, marking the subject student as not current allows teaching process manager 108 to upload such data at a later time, perhaps during off-peak time during which use of computer network 310 (FIG. 3) is relatively light.

Thus, a single human administrator using local server computer system 350 can manage use of several student client computer systems by various students, e.g., through addition, deletion, and/or modification of any of student administration records 504A-G (FIG. 5). In addition, a student can use any of teaching processes 402A-C (FIG. 4) and student response data and configuration data specific to that student are downloaded from teaching process manager 108. Students are not restricted as to which of teaching processes 402A-C they can use.

In one embodiment, teaching process manager 108 is implemented as a common gateway interface (CGI) between a hypertext markup language (HTML) document and a computer process executing within local server computer system 350 (FIG. 3). In addition, intranet 370 is a TCP/IP intranet and server module 102 acts as a firewall authorizing limited access through intranet 370 to teaching process manager 108. In this illustrative embodiment, administration of teaching processes 402A-C through addition, deletion, and/or modification of any of student administration records 504A-G can be performed remotely, e.g., either by the supervisor using supervisor client computer system 304 or by a user of server computer system 306. In addition, since TCP/IP is supported by a number of different computer system platforms, student client computer systems 302A-C can be heterogeneous. For example, student client computer systems 302A-C can be (i) a personal computer compatible with the IBM PC personal computer available from International Business Machines, Inc. of Somers, New York and based on the Pentium series of microprocessors available from Intel Corporation of Santa Clara, Calif.; (i) a Macintosh computer system available from Apple Computer, Inc. of Cupertino, Calif.; and (iii) a workstation computer system such as the SPARCstation available from Sun Microsystems, Inc. of Palo Alto, Calif. executing the ubiquitous UNIX operating system, respectively.

Student Migration between Student Client Computer Systems 302A-C

Notwithstanding the ability of students to use any of a number of computers systems at a particular site, e.g., any of student client computer systems 302A-C (FIG. 3), it is further desirable that a student can use multiple computer systems at separate sites. For example, it is preferred that a student can use one computer system, e.g., student client computer system 302A (FIG. 3), at one site (e.g., a school or workshop) and subsequently resume training through use of another computer system at home. At the same time, it is preferable that the student be restricted to use of one computer system at any one time. Otherwise, a single student registration could be potentially used by multiple individual students which not only makes proper charging for use of computer-assisted teaching system 300 particularly difficult but also makes detailed tracking of progress of individual students through a tutorial/remedial learning program particularly difficult. Thus, while a particular student can only be registered for use of computer-assisted teaching system 300 from a particular site, the student is permitted to migrate from one site to another.

Migration generally includes two steps: packing and unpacking. In addition, downloading student data to student client computer systems 302A-C from local server computer system 350 and uploading student data from student client computer systems 302A-C from local server computer system 350 similarly involves packing and unpacking as described above. Packing includes collection of all data specific to the migrating student and unregistration of the migrating student from a source site. Unpacking includes installation of all packed data and registration of the migrating student at the destination site. Packing and unpacking are described below in the context of a illustrative example in which a student migrates from student client computer system 302A (FIG. 3) to student client computer system 302C.

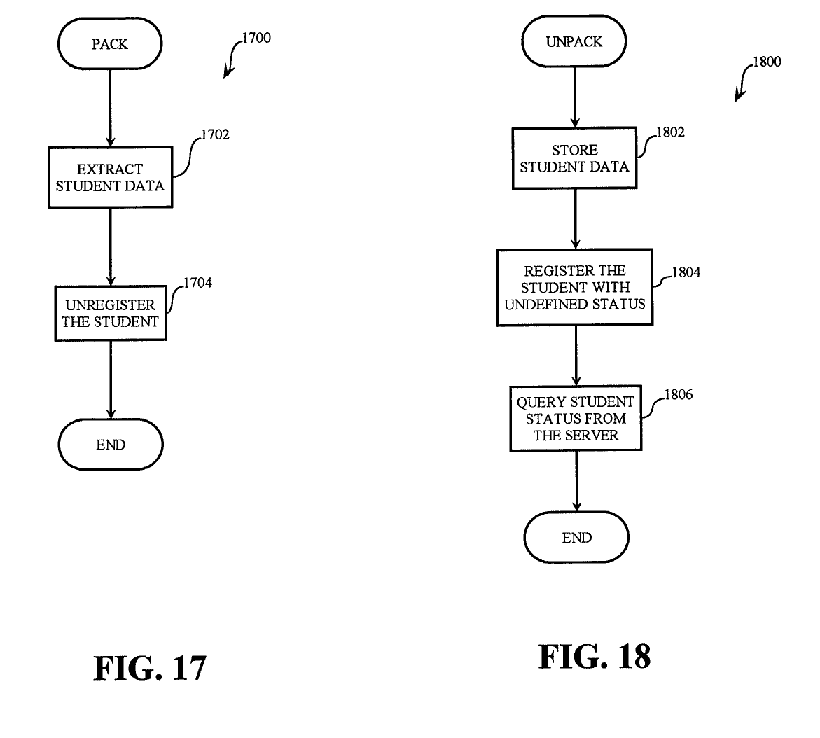

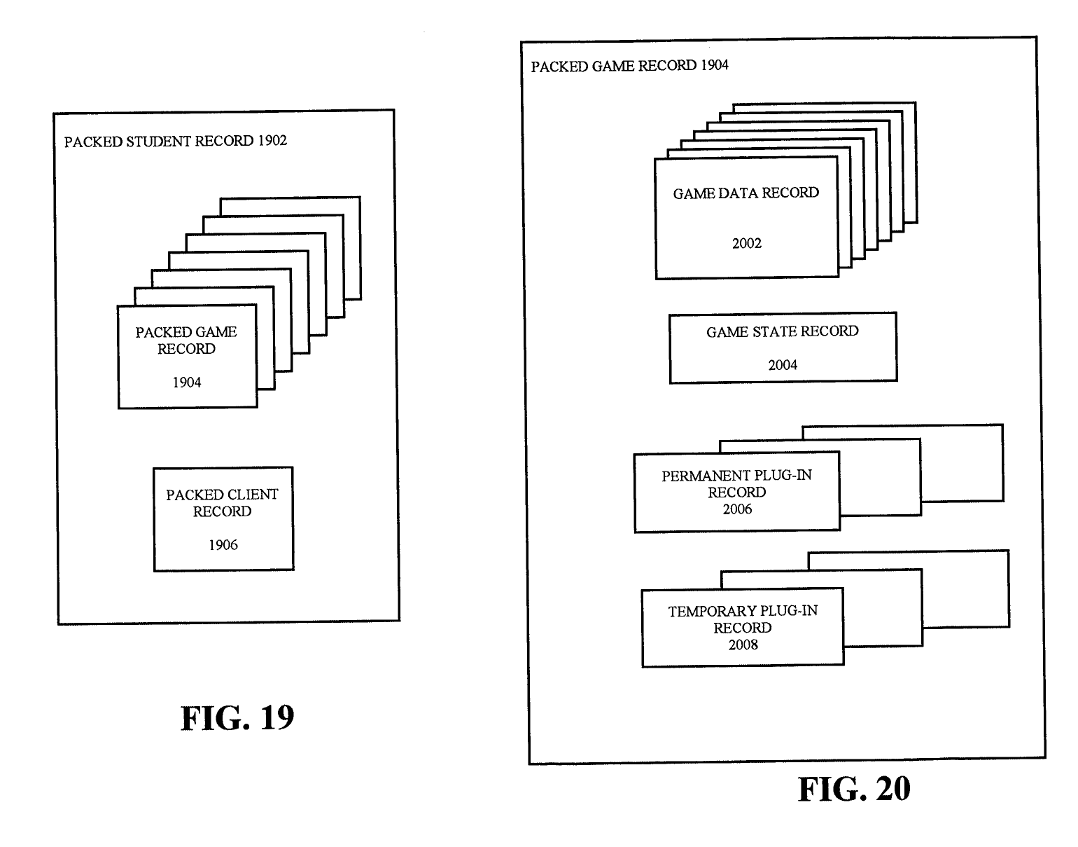

To pack, the student initiates a packing process within a migration manager 430 (FIG. 4) of student client computer system 302A, processing by which is illustrated as logic flow diagram 1700 (FIG. 17). Processing according to logic flow diagram 1700 begins in step 1702 in which migration manager 430 (FIG. 4) extracts data pertaining to the student from configuration database 406 and from student response database 404. In extracting the data, migration manager 430 stores the data in a compact, portable format and deletes the data from configuration database 406 and from student response database 404. The portable format of the extracted student data is shown in FIGS. 19-20.

Packed student record 1902 (FIG. 19) includes all data extracted from student response database 404 (FIG. 4) and configuration database 406 and is therefore portable. Packed student record 1902 (FIG. 19) can be transported from student client computer system 302A (FIG. 3) to student client computer system 302C in any of a plethora of conventional data transfer techniques including, without limitation, transfer through intranet 370 or by transfer to a portable storage medium such as a floppy disk. Packed student record 1902 includes a number of packed game records 1904, each of which represents the status of play of a particular game by the student. In addition, packed student record 1902 includes a packed client record 1906 which stores client record 902 (FIG. 9) in a portable form. In one embodiment, packed client record 1906 (FIG. 19) is an ASCII text file.

Packed game records 1904 are analogous to one another and one is shown in greater detail in FIG. 20. Packed game record 1904 includes a number of game data records 2002, a game state record 2004, a number of permanent plug-in records 2006, and a number of temporary plug-in records 2008. In one embodiment, packed student record 1902 (FIG. 19) is a directory, packed game records 1904 are sub-directories of packed student record 1902, and each of game data records 2002 (FIG. 20), game state record 2004, permanent plug-in records 2006, and temporary plug-in records 2008 is a separate data file stored in packed game record 1904. In this illustrative embodiment, the entirety of packed student record 1902 (FIG. 19) can be transported using conventional file management tools which are widely available for transportation of directories of data files.

Each of game data records 2002 (FIG. 20) stores student response data for the game represented by packed game record 1904 for a particular day. In this illustrative embodiment, the number of game data records 2002 is limited to a predetermined number, e.g., seven, such that the student must generally upload student response data to global student database 412 (FIG. 4) periodically.

Game state record 2004 stores data representing the state of the game represented by packed game record 1904 and is derived from game record 1402 (FIG. 14) which is described above.

Permanent plug-in records 2006 and temporary plug-in records 2008 each represent particular components of the behavior of teaching processes 402A-C (FIG. 4) which are specific to the student. In particular, each of permanent plug-in records 2006 (FIG. 20) and temporary plug-in records 2008 can specify data values for any of a number of data variables within teaching processes 402A-C (FIG. 4) which determine components of the behavior of teaching processes 402A-C. Permanent plug-in records 2006 (FIG. 20) are persistent and permanently alter the behavior of teaching processes 402A-C (FIG. 4). Temporary plug-in records 2008 (FIG. 20) are temporary and alter the behavior of any of teaching processes 402A-C (FIG. 4) only once. When initiated, teaching process 402A initializes data variables which define the behavior of teaching processes 402A-C. Teaching process 402A then retrieves plug-in data values for specified data variables from all plug-in records for the student currently using teaching process 402A and supersedes the initial value of any specified data variables with any retrieved data values. If a plug-in record is permanent, teaching process 402A leaves the plug-in record in tact such that the superseding data values specified by the plug-in record will be used in the next session with teaching process 202 by the same student. Conversely, if the plug-in record is temporary, teaching process 402A deletes the plug-in record such that teaching process 402A uses the superseding data values only once.

As an example of a use of a permanent plug-in module, data values can be stored in one of permanent plug-in records 2006 (FIG. 20) which marks a particular animation of teaching processes 402A-C as invalid. In this illustrative embodiment, teaching processes 402A-C periodically display audio/visual animations to the student. If the student is displeased with a particular animation, data can be stored in one of permanent plug-in records 2006 to mark that animation as invalid such that teaching processes 402A-C will never again present that particular animation to that particular student.

Temporary plug-in records 2008 (FIG. 20) implement one-time changes to the behavior of teaching processes 402A-C (FIG. 4). For example, the level of the student in a particular game can be adjusted and, since the change takes effect only once, the student is permitted to progress from that level during subsequent play of the particular game.

Thus, plug-in records 2006-2008 and game state data 2004 represent configuration data for a particular game for the student and game data records 2002 represent student response data for the particular game for the student. In addition, packed game records 1904 (FIG. 19) represent such configuration and response data for each of a number of games for the student. Packed student record 1902 therefore contains complete and sufficient information regarding the state of the student's progress through teaching processes 402A-C to be self-contained.

Processing according to logic flow diagram 1700 (FIG. 17) transfers from step 1702 to step 1704. In step 1704, migration manager 430 (FIG. 4) unregisters the student from student response database 404. Accordingly, the student must first unpack according to logic flow diagram 1800 (FIG. 18) prior to continuing use of teaching process 402C (FIG. 4). In one embodiment, migration manager 430 unregisters the student by removing client record 902 (FIG. 9), which represents the student, from student response database 404 (FIG. 4). Accordingly, the student can no longer use teaching processes 402A-C within student client computer systems 302A-C. After step 1704 (FIG. 17), processing according to logic flow diagram 1700 completes. The student can thereafter transfer the extracted student data, e.g., packed student record 1902 (FIG. 19), to student client computer system 302C (FIG. 3).

Since student client computer systems 302A-C are analogous to one another, the steps by which the student unpacks the extracted student data within student client computer system 302C is described in the context of unpacking extracted student data in student client computer system 302A and such description is equally applicable to student client computer systems 302B-C. To unpack the extracted student data, the student initiates an unpack process within migration manager 430 (FIG. 4). The unpack process is illustrated by logic flow diagram 1800 (FIG. 18) in which processing begins with step 1802.

In step 1802, migration manager 430 (FIG. 4) stored the extracted student data of packed student record 1902 (FIG. 19) in student response database 404 and configuration database 406. Step 1802 (FIG. 18) is the inverse of step 1702 (FIG. 17). Processing transfer from step 1802 (FIG. 18) to step 1804. In step 1804, migration manager 430 (FIG. 4) registers the student in student response database 404. In particular, migration manager 430 stores information of packet client record 1906 (FIG. 19) in client record 902 (FIG. 9) within student response database 404 (FIG. 4). Migration manager 430 registers the student with undefined status, e.g., by storing data specifying an invalid status in status field 928 (FIG. 9) of client record 902.

Processing transfers to step 1806 (FIG. 18) in which migration manager 430 (FIG. 4) queries the status of the student from global student database 412. By requiring migration manager 430 to retrieve status information from global student database 412, the student is prevented from unpacking periodically to reset the state of the student to an earlier state to thereby extend use of teaching processes 402A-C without authorization. In one embodiment, for example, global student database 412 stores, as part of the status of each student, a number of days until expiration of a period of permitted use of teaching processes 402A-C. If the status of the student is reset by the act of unpacking and is not verified through access to global student database 412, a student could perpetually reset status data to prevent such a period of permitted use from expiring. By retrieving the student status from global student database 412, such perpetual extension of the period of permitted use is prevented. After step 1806 (FIG. 18), processing according to logic flow diagram 1800 completes and the student can use teaching processes 402A-C (FIG. 2).

Thus, the student is permitted to migrate from one of student client computer systems 302A-C to another and yet is prevented from being registered in multiple student client computer systems simultaneously.

The above description is illustrative only and is not limiting. The present invention is limited only by the claims which follow.

what is claimed is:

1. A method for administering one or more computer processes, the method comprising:
representing status information of each of the one or more computer processes in a document in such a way that display of the document presents the status information to a user;
including in the document user interface controls by which a user viewing the document can request invocation of one or more administrative tasks, execution of which change a state of a selected one of the processes as represented by the status information in the document;
receiving a request for the document; and
sending the document to a viewer for display to the user to thereby present the status information of the processes to the user.

2. The method of claim 1 further comprising:
receiving the status information as messages from the computer processes.

3. The method of claim 1 wherein sending the document comprises:
sending the document through a computer network to the computer processes.

4. The method of claim 3 wherein the computer network is an intranet.

5. The method of claim 3 wherein the computer network is an extranet.

6. The method of claim 3 wherein the computer network is the Internet.

7. The method of claim 3 wherein sending the document comprises:
sending the document through the computer network according to a document transfer protocol.

8. The method of claim 7 wherein the document transfer protocol is a hypertext transfer protocol (HTTP).

9. The method of claim I further comprising:
receiving a request for invocation of a selected one of the administration tasks through user actuation of the user interface controls.

10. The method of claim 9 further comprising:
executing the selected administration task in response to the request.

11. The method of claim 10 wherein the administration task includes correcting the status information of a selected one of the computer processes to indicate that the selected computer process is not currently in use.

12. The method of claim 10 wherein the administration task includes correcting the status information of a selected one of the computer processes to indicate that a particular user is using the selected computer process.
